(19) United States
(12) Patent Application Publication
(10) Pub. No.: US 2023/0306352 A1
(43) Pub. Date: Sep. 28, 2023

(54) INTERACTIVE ELECTRONIC EVALUATION SYSTEMS AND METHODS

(71) Applicant: Next Jump Inc., New York, NY (US)

(72) Inventors: Yong-Chul Charles Kim, New York, NY (US); Meghan Messenger, New York, NY (US)

(21) Appl. No.: 18/160,176

(22) Filed: Jan. 26, 2023

Related U.S. Application Data
(60) Provisional application No. 63/303,930, filed on Jan. 27, 2022.

(51) Int. Cl. G06Q 10/0639

(52) U.S. Cl. CPC G06Q 10/06398; G06Q 10/06393

(57) ABSTRACT

Systems, methods, and computer readable medium are provided that relate to improvements in digital human resources technology. An automated system can be provided in which the user can have a digital interactive private space and use the space to conduct interactive assessment of five traits and to select to collect additional data from others on the five traits about the user, and includes automated algorithms that classify and detected patterns from numerical data which for example can use interrelationships between different types of data. The system is configured to record the information in the private space, provide the assessment, and allow the user to maintain the information to be private to the user while being configured to able to be maintained to allow the user to return to the private space at a later time (as configured by an application, service, and server) to perform the interactive assessment and detection of classifications. Embodiments combine interactive visual radar graphs with classification and reports.

### CROSS-REFERENCES TO RELATED APPLICATIONS

This application claims the benefit of priority to U.S. Provisional Pat. Application No. 63/303,930, filed Jan. 27, 2022, the entire contents of which are herein incorporated by reference.

### FIELD OF THE INVENTION

The present invention is generally related to the field of digital interactive human resources technology, including employee evaluation, assessment, development, and decision-making training systems.

### BACKGROUND OF THE INVENTION

Employees are perhaps the most valuable asset of an organization. Keeping and attracting employees often requires that the organization invest resources to develop the employees. For example, evaluation of employees of an organization is an important and valuable exercise for better management of the employees and the organization as a whole. It can take many forms: supervisor evaluations of subordinate employees, peer-to-peer evaluations, so-called “360” evaluations whereby personnel are evaluated by supervisors, subordinates, and peers, and many other variations. The logistics of conducting evaluations is also varied, with evaluations being conducted in written form, as part of face to face meetings, through electronic means, or some combination of these or other formats. The use put to completed evaluations also varies, with evaluation results being used to develop, promote, discipline, reassign, train, or otherwise affect the evaluatee and the management of the organization.

Traditional performance evaluation processes tend to be provided by managers for their employees annually. The evaluation data may be objective (based on measurable criteria such as productivity and quality standards), subjective (based on the manger’s perceptions and observations), or a combination of objective and subjective criteria. This type of performance evaluation often suffers from drawbacks, causing dissatisfaction for both the manager and the employee and failing to achieve the primary goal of improving the performance of the individuals and the organization. Common problems with traditional performance management processes is that the processes are not adapted to provide interactive tools for employee growth and development. The problem can be complicated by not having real and identifiable numerical measurements that are normalized across an organization to accurately and objectively measure employee performance and growth. Other drawback and deficiencies also exist and would be understood to those of ordinary skill in the art.

In the field of interactive evaluation applications, such applications are directed to towards providing the administration of the company such as the human resources department to conduct annual evaluations. Such evaluations often times limit the employees accesses to the evaluations such providing them during the evaluation meeting and involve only evaluations selected by the company to submit evaluations. Such applications serve to allow for the assessment of job promotion or advancement by the company but do not provide features for employee to self-evaluate and develop improvements through interaction with the tool.

There are also deficiencies related to providing effective tools for assessment and decision making, which are important to company and having a high performing workforce.

Accordingly, there are deficiencies to be addressed and improvements sought over existing digital interactive human resources technology tools and systems.

### SUMMARY

In accordance with the principles of the present invention, embodiments of systems, methods, or computer readable medium provided that implement advancements in human resources technology that provide automated private tool personal to an individual user that at least by indirect operation and guidance improve the personal skills of the user. In some embodiments, a computer-implemented method is provided that is a guided interactive self-evaluation service. An application can be implemented that can be running on a server. The application is configured to provide employees of a company with the service. The method can include implementing the application to provide an interactive user interface to the employees, wherein the interactive user interface is adapted to provide individual users with an automated self-assessment process, and implement the application to establish a private space that the individual user can configure to limit access by other employees to the user’s private space, wherein the application is configured to provide access to the private space via a browser to the individual users and is configured to invite one or more other users to have access to the individual user’s private space.

The application can be configured to permit the individual user to perform an automated self-evaluation using the application, the evaluation comprising numerical ratings for the five attributes and a free-style text narrative. The application can be configured to permit the individual users to self-select, using the application, other employees to perform a peer-evaluation of the individual user on the service, the peer evaluation comprising the numerical ratings for the five attributes and one or more additional free style text narrative. The application can be configured to receive and store the numerical ratings for the five attributes and the free-style text narratives.

The application can be configured to store a library of algorithms that are each configured to detect a classification by detecting patterns in the numerical ratings that satisfy one of the algorithms. The application can be configured to detect one or more of the classifications for individual users using the received numerical ratings for the five attributes from the self-evaluation of the individual user and a plurality of the peer evaluations for that individual user.

The application can provide using the graphical user interface (e.g., by way of transmitting data to a mobile device or a browser, or running locally and remotely, etc.) the ability for individual users to view in the individual user’s private space a structured report based on the numerical ratings from the self-evaluation and peer evaluation, and the report comprising the detected classifications for the individual user, and in conjunction with providing the structured report, display an interactive radar chart displaying the numerical ratings of the self-evaluation and a combination of other evaluations for that individual user each as a connected polygon shape

The application can be configured to store the structured report including the detected classifications of the individual user; and configure the application to allow the users to return to use the application at later times to again perform the self-evaluation and peer evaluations and allow the user review historical data from previous reports in the private space.

The application can comprise anonymizing the evaluations such that they are not associated with identification of the one or more peers. The anonymizing can comprise removing identification information form received evaluation as part of storing the evaluations.

The service can be implemented on a company’s enterprise network that the user’s can interact with using a web browser, for example.

The application can be configured to a list of employee of the company for user’s to select from to request peer evaluations.

The service being configured update the algorithms at one more later dates at the server such as to refine the algorithm for a particular classification or to add new algorithms for new classifications.

The data that is used in the algorithms can be data (e.g., numerical rating) from the self-evaluation or evaluations for an individual user by others and can include representative data or data based on the that date. For example, average of multiple a numerical rating for an attribute or other formula can be used. The patterns are detected in the numbers by for example evaluating the data or such processed data, and/or interrelationships between data to detect the defined patterns corresponding to classifications. An individual can have a coach that is provided access to view all or certain information in the individual user’s private space. The user can select one or more coaches.

Related non-transitory computer readable medium and systems are included in the description herein as it would be understood by the reader.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 illustrates one embodiment of the system for evaluation of employees in accordance with some embodiments of the invention;

FIG. 2 illustrates another embodiment of the system for evaluation of employees in accordance with some embodiments of the invention;

FIG. 3 illustrates a flow process showing a communication between the evaluation software application and the evaluation processing software application in accordance with some embodiments of the invention;

FIG. 4 illustrates a part of an example user interface that allows an evaluatee user to select an option in accordance with some embodiments of the present invention;

FIG. 5A illustrates part of an example user interface that allows an evaluatee to solicit evaluations from peers or coaches in accordance with some embodiments of the present invention;

FIGS. 5B-5C depict flow processes for solicitations of evaluations, in accordance with some embodiments of the present invention;

FIG. 5D illustrates part of an example user interface that allows a registered evaluator to access an evaluation form, in accordance with some embodiments of the present invention;

FIG. 5E illustrates part of an example user interface that allows an unregistered evaluator to access an evaluation form, in accordance with some embodiments of the present invention;

FIG. 6 illustrates part of an example user interface of the evaluation software application that allows a user to complete self-evaluations in accordance with some embodiments of the present invention;

FIG. 7 illustrates part of an example user interface of the evaluation software application that allows evaluators to create peer/coach evaluations in accordance with some embodiments of the present invention;

FIG. 8A (provided as a group of drawing sheets due to size limitations comprising 8A, 8A-1) illustrates part of the user interface to allow an evaluatee user to view submitted evaluations and corresponding evaluation analytics in accordance with some embodiments of the present invention;

FIG. 8B (provided as a group of drawing sheets due to size limitations comprising 8B, 8B-1, 8B-2, 8B-3) illustrates a detailed evaluation report in accordance with some embodiments of the present invention;

FIG. 9 illustrates a flowchart describing the process of identifying and deriving the personality profile of an evaluatee in accordance with the present invention

### DETAILED DESCRIPTION OF THE INVENTION

In accordance with the principles of the inventions, advances in HR technology provided by way of interactive computer implemented tools, software processes, and systems that improve on existing employee evaluation technology. There are many advantages and valuable aspects of the present technology and a few such aspects are initially discussed.

Based on research conducted, there is a need for digital interactive tools that materially advance an employee’s self-development and in particular, materially improve an employee’s decision-making skill. Decision making is a critical aspect of employee performance that is historically underdeveloped and difficult to assess. There are also difficulties in identifying and implementing successful and accessible solutions that benefit the employees. Systems developed in accordance with embodiments of the present invention provides an accessible and efficient interactive tool by way of an interactive evaluation application and related features that provide a material improvement in this field. Through research, certain (limited) attributes have been found to have a close relationship with evaluating and improving decision making skills. Those attributes being: (1) future outlook, (2) measuring progress, (3) discipline in the hard stuff, (4) speed and boldness, and (5) truth, which are further described or applied below. The system is configured to implement a software tool for evaluation that integrates these attributes and related features to develop the user’s decision-making skill (e.g., over time by reusing the tool and learning from the interaction). An evaluation tool in the workplace can be a useful tool for employees to understand their strengths and weaknesses, and improve the identified strengths and weaknesses through self-awareness. Other applications or attributes (beyond decision making and/or specified attributes) are contemplated. Preliminary research has shown that various direct and indirect interactions with the tool provide particularly beneficial improvements to employee performance while also providing a very convenient and efficient software solution. As such, in some aspects, the systems and software described herein develop a new form of technology that implements a decision making training system.

Embodiments of the present invention provide a quantitative assessment of decision making related skills of an individual by analyzing inputs to interactive questions provided by the individual and his or her peers, coaches, and/or family members (for improvement in accuracy). The quantitative assessment may be used by the individual for developing a training program (e.g., selection of specific training modules) — with or without a coach — for improvement and/or development of his or skills (e.g., decision making skills. For example, if the evaluation analysis determines that the individual has a reckless trait that is greater than a threshold, the system may identify and/or help the individual identify exercises or training programs for improvement of the attribute. Specifically, the tools of embodiments of the current invention quantify, based on the inputs, current behavioral characteristics (as interpreted by the system using the data) such as an individual’s thinking patterns, gaps in awareness, and areas of balance/imbalance, which directly impact decision making. The questions relate to the following five factors or attributes: (1) future outlook (as a measure of effectiveness at establishing and inspiring others towards a goal); (2) measuring progress (as a measure of effectiveness at identifying trends, maintaining perspective, learning lessons from the past, etc.); (3) discipline in the hard stuff (as a measure of consistency and discipline in tackling difficult work); (4) speed and boldness (as a measure of speed and boldness to action, which considers an individual’s ability to make trade-offs); and (5) truth — no lying, hiding or faking (as a measure of how authentically an individual communicates with others and his/her ability to seek out truth). Embodiments of the present invention relate to a structured system using a combination of software, hardware, data structures, security, and restrictions to provide an advanced interactive electronic evaluation system. For example, an application can be implemented that provides employees of a company with an interactive user interface that is adapted to provide the user with the ability to self-evaluate themselves with respect to a set of attributes, preferably a set of five attributes: future outlook, measuring progress, discipline in the hard stuff, speed/boldness, and truth. The application is preferably configured to establish a private online space (e.g., accessible via a mobile application or website user interface) that the individual user can configure to limit access to his/her private space. The space is where the user can view his or her self-evaluation ratings (numerical rating on each attribute, free text evaluations), and which can be configured to allow others — specifically one or more invited coaches — to have access to the information in that private space. The application is configured to allow the user to also self-select peers (including, for example, colleagues, supervisors, etc.), family members (e.g., friends, family, or anyone who is not a peer or a coach) and/or coaches to conduct the same evaluation of the user, provide the numerical evaluation for each attribute and also provide an interface to write in free style an evaluation for one or more attributes or one overall evaluation for the user. If desired, the system can be configured to limit the length of the text evaluation such that the peer is forced to refine their thinking to a short meaningful message knowing that it would be shared with the user. The application is configured to receive the peer and/or coach evaluations and when requested (subject to some conditions or restrictions such as whether all peers have completed the evaluation) provide the peer evaluations, preferably in an anonymous state, to the user. In other words, the application can strip or remove the identification of the peers and/or coaches before sending the evaluation to the user’s private space. In some implementations, the application, can implement an operation that when reporting the peer evaluation only retrieves the data from the evaluation information but not identify peer (retrieve that information) when generating the report for the user. Specific rules can be implemented, such that access to anonymized evaluations (e.g., from peers) is not enabled until at least a threshold number (e.g., 3, 4, 5, etc.) of evaluators submit their reviews/evaluations. Other measures to securely maintain anonymity are also described herein. The privacy and control over access to data can be implemented by way of tables that specify the information that an individual user that logs in has permission to receive (e.g., would check whether a user is a coach to another user based on the table entry and would retrieve and display the user’s self and peer evaluations in the coach’s private space based on the permissions in the table). It should be noted that while the following disclosure describes the invention in the form of a mobile application, it is not so limiting, and can be implemented as a website including an interactive user interface. It can be implemented as a web application in combination with a mobile application.

The application can be configured to allow the user to only be able to select peers from the company by way of integrating the company’s enterprise computer system into the operation to only provide co-workers as selectable options. If desired, the user can be provided with the option to select people outside of the company by specifying their email address in order to have them access the application to provide input to the user. Generally, further reflecting that in some embodiments, the self-guided process is controlled to be the user’s selection of the peers and coaches.

The application can include an analysis and reporting system or software engine and reporting component. As a matter of background, typically company evaluation or self-assessment systems provide a direct rating for a particular specific question and the meaning of the combination of evaluation information is left for the subj ective understanding of the employee and the human resources department. The conventional tools do not implement advanced features that allows for self-evaluation analysis and detection of indirect information as a function of the interrelationship of the different attributes, that is consistent across multiple companies and/or within a company. For example, by way of the software engine, a system is implemented that stores a library of algorithms that each have a corresponding classification and related stored data when a classification or state is detected. The software engine is configured to apply the library of algorithms such as by evaluating the numerical scores for each attribute and detecting whether one or more of the algorithms are completed/satisfied, e.g., detecting a classification. There algorithm can include many levels of complexity, such as being able to detect interrelationships between certain attributes. For example, does the average of the first and third attribute result in a higher number than the score of the second attribute. Or, for example, does the average of the first and third attribute result in a higher number than the score of the second attribute while the score for the second attribute is lower than each of both the fifth and fourth attributes. A complex analysis of many different patterns can be detected and classified from the automated data analysis based on a corresponding library of information. The classifications through the algorithm and the stored classification information can be used to display the detected classifications or other automated assessments to the user through a structured report that is displayed to the user in the application. The report can be displayed in conjunction with a radar chart that provides an interactive radar display. The classification and report process provides the same data to (all) users in the company when a classification is detected and the classification is only provided (software limits access to the data) to the user’s private space and selected coach(es).

The process is structured to have a set of specific (different) categories of classifications that the software engine detects and reports for example a predetermined set of separate sections in the report which is configured to provide a structured view of the report. The system provides an objective evaluation system in a manner that is consistent for all employees.

There can be a provider of the application that can maintain the library of classification and retrieved data locally or remotely. The provider can periodically update the tool to refine the accuracy and content based on additional employee interactions. With this information, an employee is enabled to self-guide personal development of skills to improve attributes in a level way relative to others at the company. The application is further configured to be available to the user to perform the self-evaluation and select peer requested evaluation over time (e.g., every three months) and the application can maintain a history of each iteration so that the user can also benefit from viewing historical information via a graph and reports. A web interface can be provided for the various features such as in combination with a mobile application. Various embodiments are contemplated such that for example individual features may by themselves have critical implementation value or may have it in various combination of features herein.

Embodiments of the present invention are directed to a system for implementing evaluation tools for employees of an enterprise. In at least some embodiments, the system implements an interactive structure that establishes an employee evaluation system that allows the employees to perform self-evaluations, solicit evaluations from peers, as well as solicit evaluations from coaches or family members/friends. The employee evaluation system provides the additional advantage of providing an individualized platform to the employees that displays the solicited evaluations only to the corresponding employee and/or the employee coach allowing the employee to identify potential areas of improvement and/or develop strategies for improvement in the identified areas using the particular electronic interface that is provided in the system. As part of the system, evaluation applications (e.g., evaluation software application) are implemented on either personal mobile devices or via a web interface, that are configured to provide interactive evaluation tools to the user on the display of the mobile device or other electronic devices.

The evaluation application is configured to send login and password information to a personal identity service, wherein the personal identity service receives and authenticates the user, provides or sends an electronic security token to the evaluation application that the evaluation application sends to the evaluation service (e.g., evaluation processing software application) to obtain authorization to operate in the service. The authentication and the system is configured to use the authorization token to enable access to other services offered on the enterprise network of that company or by that enterprise employing that user to gain access to the other services (e.g., to all other services or join the enterprise network and have access to enterprise application such as evaluation processing software application). This process provides efficiency in that the user and system do not require separate logins for each of the enterprise’s applications to access corresponding services. In addition, it can protect anonymity because it can disassociate the evaluator’s login or name from the interactive process in the evaluation service. The interactive process in the evaluation service can use a numerical or alphanumerical identifier (or other non-descriptive identifier) for communications (in the packets or messages) to the service that would not be understood visually or otherwise easily used to identify the user of the mobile device. In addition, the security process and the use of tokens establish highly secure inter-system relationships and connections (e.g., trusted connections using communications and security protocols) based on identity authentication and security tokens used in messaging. The evaluation service, for example, may be the evaluation processing software application described below.

The evaluation application (e.g., the evaluation software application) is configured to provide the user with interactive tools available from one or more display screens displayed by the evaluation application on a user’s mobile device or as a web application on other electronic devices. The evaluation application is configured to display an option to solicit evaluations from evaluators, prepare and send evaluations directed to evaluatees, an option to receive and view evaluation (evaluation messages) and corresponding analytics.

The system is configured to provide the employee with an interface on their mobile device wherein the interface provides or consists essentially of an option to create and submit self-evaluations, select evaluators for peer, family member, and/or coach evaluations, and to view the evaluations and various graphical outputs.

The system is also configured to provide evaluators with an interface wherein the interface provides or consists essentially of an option to select evaluation rating and a text area permitted to enter their evaluation in freestyle using text entry, via an evaluator’s mobile device or as a web application on other electronic devices. The system is configured to provide the interface on the user’s personal mobile phone by having an application running on the mobile phone. This can provide security, speed of use, and other benefits such as a reduction on employee’s hardware resources.

The system (e.g., available on employees mobile phone, which is almost always with a user) provides for quick entry of evaluation. The system is configured to provide employee to employee evaluation (one to one) and preferably without restrictions such as seniority or role. The system is also configured to maintain the identity of an evaluator who has given an evaluation anonymously. Furthermore, the system is configured to have the evaluations only be accessed by an evaluatee or coaches invited by the evaluatee, and not by other employees of the company.

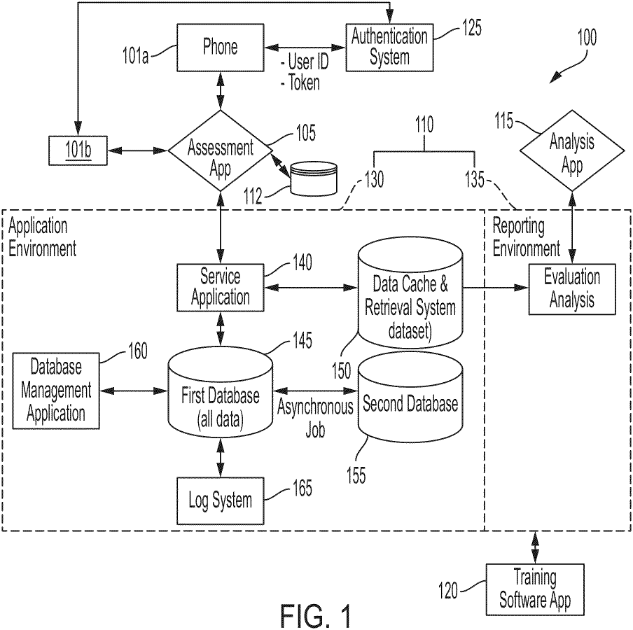

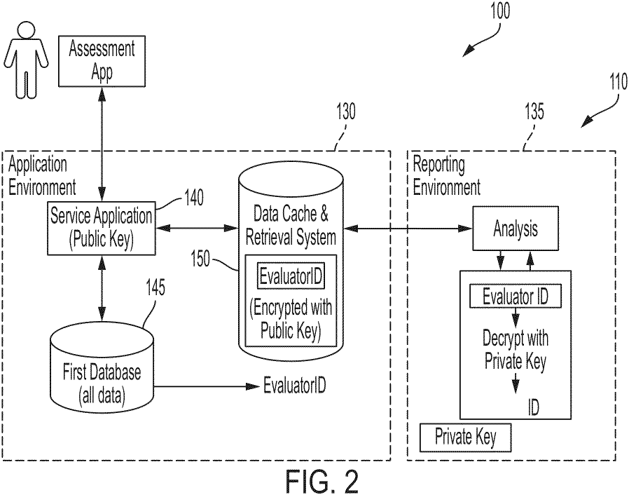

The mobile application (e.g., evaluation software application) is preferably configured to be a lightweight application that places minimal processing or storage requirements on the personal mobile telephone. The mobile application generates the interactive display screen, providing interactive tools. The information that is displayed in the mobile application is retrieved after the user opens the application (from a closed state) and is running on the mobile phone. The mobile application will request the information in response to the user selecting an interactive option (e.g., selects to give evaluation, and list of employee names are retrieved). An HTTP GET command can be used for this process. For example, when the user selects the option to view the queue or report of employee-to-employee evaluation given in the enterprise, the mobile application in response transmits a command requesting the messages. The service (e.g., evaluation processing software application) responds by sending a set of the most recent messages that the service received and saved on the enterprise search platform (e.g., system 150 in FIG. 1) implemented in the service. The service can respond by sending a first set and in response to the user scrolling or searching the messages, the service can send supplemental messages to allow the user to see additional messages in the feed. Preferably, the service and mobile device operate in this incremental process rather than to transmit all or a significant portion of the messages to the mobile application, which can slow down the mobile phone and the service and can raise security issues.

The mobile application (e.g., evaluation software application) uses the local volatile memory (e.g., a cache or memory buffer) of the mobile device to store the information, such as the queue of evaluation messages at the company, on the mobile device in supporting the operation of the application including the ability to present display screens that include the received information. Preferably, when the user closes the mobile application on the device, the received information is no longer accessible because it was part of non-volatile memory and it frees up the storage on the mobile telephone for other applications.

The mobile application (e.g., evaluation software application) is configured to communicate with an evaluation service (e.g., evaluation processing software application) implemented on a server using interactive data messaging such as by using HTTP GET and HTTP POST messages. Preferably email protocol messages or chat messaging is avoided and is external to and/or independent from the mobile application. The mobile application prepares messages to interact with the service by creating the data portions of the message and associating related tags, and further using JSON on the mobile phone to prepare communications messages (or packets) on the mobile device, which are transmitted by the mobile device over wireless networks such as WiFi or mobile telephone networks.

Another application that can be configured to work over or in conjunction with this system is an evaluation processing application. The data collected by the system from the evaluation process can be saved and used in conducting analytics by the evaluation processing application

The implementation of an electronic system that configures anonymous employee evaluation to other employees establishes an incumbent platform for use by company employees. It is possible that (for example as a matter of operational or system efficiency) other systems or objectives would be integrated into or combined into the operation of this electronic system. How to implement such integration without negatively impacting the operation and effectiveness of the evaluation systems presents a technological problem to developers. By integrating a second application in the evaluation system, the company can avoid having to develop and/or institute separate systems or software for the other obj ective(s). At least in one respect, embodiments of the present invention integrate an electronic employee evaluations system in a seamless and efficient way into the evaluation system. The evaluation system is integrated with a user interface for the entry of evaluation to other employees using a particular interface that puts the user in a position to freely write the text for an evaluation (e.g., without specifying multiple categories of rating criteria or without providing canned language that they could reuse), and specify ratings for a set of attributes.

The evaluation system implements interactive tools that can be used by users to evaluate various behavioral attributes, which are then analyzed to quantify insightful characteristics (e.g., thinking patterns, gaps in awareness and areas of balance/imbalance) of an employee. Known techniques or algorithms did not use or implement such technology and were inaccurate in their determination of such behavior because they do not take into consideration an employee’s unwillingness or ability to provide accurate responses. The system implements algorithms such as an evaluation of employee behavior that accurately determines how the employee is behaving with respect to his peers or coaches, and the employee’s own cognition of the behavior/ behavior patterns by soliciting and combining peer/coach evaluations with self-evaluations provided by the employee. The system is configured to apply an algorithm to the feed of evaluation messages (and data contained therein) and determine the behavior/ behavior patterns as quantifiable characteristics. The radar charts can provide a reliable and accurate assessment of employee behavior. The automated classification and report generation process relies on a software engine and underlying rules.

Implementations and embodiments of such systems, interactive tools, applications, or interfaces (etc.) in accordance with principles of the inventions are further described below. The discussion includes additional relevant details depending on the embodiment and advantages and technical benefits are also described or understood from the explanation. The term evaluation system is sometimes in recognition that the described system involving evaluations is directed to electronic interactive systems involving evaluations and skills development.

Embodiments of the invention are directed to systems and methods for evaluation of employees. The contemplated system essentially includes an evaluation application and an evaluation processing application. The evaluation application can be installed on a mobile device and/or provided as a web interface on an electronic device and used by an individual to solicit peer/coach evaluations, submit self-evaluation, and view evaluation data or results. The evaluation application allows the individual (evaluators) to compose an evaluation freely with his own words. The evaluations are displayed anonymously in the evaluation data and results without showing the evaluator’s identity. The evaluation processing application provides the data that is displayed in the evaluation data and results. The evaluation processing application is installed on a server and is used to provide anonymous evaluations to the evaluation application. The evaluation application sends the evaluation to the evaluation processing application. The evaluation processing application processes the evaluation to withhold information identifying the evaluator and provides the evaluation without the evaluator’s information to the recipient and/or one of the data feeds. The evaluation application can also send requests to the evaluation processing application to retrieve the data for other feeds. The evaluation processing application includes a first database containing sender’s information and a data cache and retrieval system that is devoid of sender’s information or has sender’s information encrypted (in general, it should be understood that various combination are contemplated). The first database is protected with security measures or security configuration so that no one (except authorized users) can access it to determine the identity of their evaluators. The evaluation system may also include an analytics application that is used to analyze user’s evaluations, and output various metrics in the form of graphical representations such as radar charts.

Technical improvements over the prior art can for example include:
A flexible tool allowing users to compose their own and true evaluations without being restricted to certain terms or selections or being filtered or otherwise modified. The flexible tool may limit the amount of text an evaluator may include in the evaluation;
Software applications and systems that can process and provide anonymous, original evaluation to recipients;
A classification engine that utilizes radar charts and various rule sets to determine behavior patterns or personality traits of an evaluatee;
Software applications and systems that can limit access provided to an evaluatee until sufficient number of evaluations are collected;
Software applications and systems that can limit access to certain enterprise resources until employee performs certain actions in evaluation;
Private self-development space based on self, peer, coach, and/or family member evaluations and automated analytics;
Use of the evaluations and automated analytics for development or improvement of one or more skills (e.g., decision making skills) of the evaluatee;
A virtual container system for providing bundled software, libraries, and configuration files for executing the systems and methods of embodiments of the invention in a manner that is isolated from other virtual machine instances/applications/data for preserving security and integrity of information contained therein; and
Structured reports and visual graphics.

Other improvements of the invention will become apparent from consideration of the drawings and ensuing description. The contemplated systems and methods provide a truly anonymous evaluation mechanism that can be used safely and effectively motivate improvements in decision making skills, teamwork and quality.

The personnel, which may include all of the personnel of the organization or only a subset thereof, are divided into two groups: evaluator and evaluatee. The evaluator are personnel capable of performing an evaluation of other personnel, including themselves (i.e., capable of performing a self-evaluation). The evaluatees are those personnel to be evaluated by the evaluator. There may be one or more personnel in the evaluator group and one or more personnel in the evaluatee group. In various embodiments, the group of evaluators may completely or partially overlap with the group of evaluatees. Optionally, the two groups may be separate and distinct. While the current disclosure describes the evaluator as belonging to the organization, the disclosure is not so limiting and in various scenarios certain evaluators may be personnel that are not employees of the organization (e.g., family members or friends of an evaluatee solicited to provide peer evaluations).

As used herein, a “self-evaluation” refers to an evaluation where the evaluator and the evaluatee are the same person; a “peer evaluation” refers to an evaluation provided by an evaluator who is not solicited as a coach by the evaluatee for mentoring or training the evaluatee (e.g., another employee of the same company, a supervisor, a friend, or a family member); and a “coach evaluation” refers to an evaluation provided by an evaluator who is or will be a coach selected by the evaluatee for mentoring or training the evaluatee. And a “family evaluation” refers to an evaluation provided by an evaluator that is related to the evaluate, such as a spouse, and/or someone who is not a coach or a peer. While some of the disclosure below describes peer, coach, and self-evaluations as examples, the disclosure is not so limiting. For example, family evaluations can be solicited, provided, and analyzed (including anonymization) similar to the peer evaluations.

FIG. 1 illustrates one embodiment of the system 100 for soliciting, analyzing, and using employee evaluations. The system includes an evaluation software application or assessment software application (which for brevity is referred to herein as evaluation application) 105 installed on a first electronic device 101(a), and at least a second electronic device 101(b) that can communicate with the evaluation software application 105 (collectively, the evaluation portal system). The first electronic device 101(a) may be used by an evaluatee for, for example, selection of peers and/or coaches, soliciting evaluations from peers and/or coaches, providing self-evaluations, reviewing evaluations (or corresponding analyses), development of skills and/or receive training based on the evaluations (self or with a coach), or the like, via the evaluation application 105(a). The second electronic device 101(b) may be used by an evaluator (e.g., peer or coach) to, for example, receive solicitations for evaluation, provide secure and anonymous evaluations, and/or assist the evaluatee in development of skills and/or training (e.g., as a coach), or the like, via the evaluation software application 105. The system further includes an evaluation processing software application 110 implemented on one or more servers (evaluation processing system), an analytics software application 115 implemented on one or more servers (evaluation analytics system), and a training software application 120 implemented on one or more servers (training system). The electronic device is preferably a mobile smartphone that is handheld and capable of downloading and installing mobile applications that can communicate through the mobile phone with server via mobile networks or other wireless networks. Optionally, the electronic device can be personal computers, servers, mainframes, virtual machines, containers, gaming systems, televisions, and mobile electronic devices such as tablet computers, laptop computers, and the like. Each of the electronic devices and servers is a computer system that includes a microprocessor and volatile and non-volatile memory to configure the computer system. The computer system also includes a network connection interface that allows the computer system to communicate with another computer system over a network. The evaluation processing software application 110, the analytics software application 115, and the training software application 120 may be implemented on the same severs or different servers. The system may include one or more of the aforementioned software applications, instead of all three. Each software application may also be used independently or in conjunction with another software application (a software application other than the above three software applications) to strengthen or supplement functionalities of the other software application.

The evaluation software application 105 includes a login interface and performs a user authentication process to allow the user (a registered evaluator and/or an evaluatee) to access the evaluation software application. It should be noted that the evaluatee may be provided a first type of access that allows them to solicit evaluations, review evaluations or evaluation analyses, and use the evaluations for skill development/training with or without a coach. In other words, the first type of access allows the evaluatee to access his/her private space. On the other hand, evaluators may be provided with a second level of access that only allows them to submit a solicited evaluation (e.g., when the evaluator is a peer) and/or a third level of access that allows them to submit a solicited evaluation, as well as work with the evaluatee to review evaluations or on skill development/training (e.g., when the evaluator is a coach). The different levels of access may be configured automatically (e.g., using a rule set) based on the role of the user (i.e., evaluatee, peer, or coach) using the evaluation software application and/or may be configured by the evaluatee. The application may also be configured to condition such access on the user having performed certain tasks in the evaluation system (e.g., solicit evaluations, submit self-evaluations, submit peer/coach evaluations, etc.). For example, before an evaluatee user can view his evaluations and associated analytics for the first time, the application may require the user to submit a self-evaluation and receive a certain number of peer and coach evaluations. This system may also be used to unlock access to other information in the application and/or to enterprise wide other applications. The system can be configured using the permissions to block the individual user’s employer, supervisor, human resources department or others from being able to access the individual user’s evaluation data (e.g., their private space of self, peer, and coach evaluations and reports) unless access is authorized by that user such as by being a coach selected by that user.

The evaluation software application is also configured to send reminders or notifications, whether in the evaluation software application or through email. In some embodiments, the notifications are generated to, for example, solicit evaluations, submit solicited evaluations, view evaluations, review trainings, etc. The notifications may be provided by the evaluation software application such as through push notification, a pop-up window, sound, or vibration, or by the system or EMS sending an email with the reminder.

A user can enter his or her sign-in credentials from the login interface through the electronic device and the entered information is transmitted over a network to another computer system by the electronic device. The computer system receiving the user’s credentials may be an authentication system 125 that may be part of the system 100. For example, the sign-in credentials of an employee may be his company sign-in credentials that include information that identifies that the user is an employee of the company, such as an email address based on the company’s email domain, employee identification number, or other employee identifiers. Upon receiving the credentials, the authentication system checks if they (e.g., an email address and password) match the credentials stored in the authentication system (e.g., the email address and password pre-stored in the authentication system). The credentials stored in the authentication system, for example, may be created and stored in the authentication system when the person joins the company and the human resources department of the company creates an email address and password for that person through the company’s computer system. The credentials stored in the authentication system can be updated when the user changes his credentials (e.g., password). The authentication system is configured to store sign-in credentials of the employees hired by the company. This authentication implementation is configured to use the authorization token to enable access to services offered on the enterprise network of that company or by the enterprise employing that user to gain access to the services (e.g., to all other services or to join the enterprise network and have access to enterprise applications such as the evaluation software application and employee database). This process provides efficiency in that the user, or the system implementing each enterprise application, does not require separate logins for each of the enterprise’s software applications on the user’s electronic device to access corresponding services. At the same time, this process also establishes highly secure inter-system relationships and connections, such as trusted connections using communications and security protocol, based on identity authentication and security tokens to ensure that unauthorized individuals or individuals outside the enterprise do not have access to the enterprise applications. This security implementation provides a simplified authentication process or one single authentication process that can simultaneously verify that the user is an employee of the company and allow the user to access all enterprise applications on the enterprise network. In contrast, conventional systems require a separate authorization process for each procedure, such as an authentication process for verifying whether the individual is an employee, a separate authentication process for granting access to one of the enterprise applications after verifying that the individual is an employee, another separate authentication process for granting access to another one of the enterprise applications after verifying that the individual is an employee, and so forth. In some applications, employees use their own personal mobile phone on the premises of the employer or remotely, which would implement the mobile application and would then connect to the enterprise software platform through the authentication process. For example, the device could be an external device that is receiving the benefit of enterprise resources through logging via cellular data, another company’s WiFi, or company’s WiFi.

Optionally, the sign-in credentials may be different from company sign-in credentials. In such examples, for first time users, the user’s credentials may be generated by the authentication system 125. In some embodiments, first time users can also create their own credentials from the login interface.

Upon receiving the credentials, the authentication system 125 checks if they match the credentials stored in the authentication system (stored as a result of the authentication system generating the credentials for first time users creating the credentials). If they match, the authentication system 125 generates an authorization or security token and sends it over the network to the electronic device 100. The evaluation software application 105 incorporates the token into all of its data to or communications with the evaluation processing software application 110. The token is required to communicate with those software applications and is checked and verified by those software applications before the evaluation software application 105 can access the functionalities and data in the evaluation processing software 110 and/or employee database 112. The authentication system 125 may generate a user identifier in response to the match and can transmit it over the network to the evaluation software application 105. The user identifier may also be included in some or all of the evaluation software application 105′s data or communications with other software applications and/or electronic devices. The token is required to communicate with those systems and database and is checked and verified by those systems and database before the evaluation software application can access the functionalities and data provided by those systems and database. The user identifier may be a code or number that only the system or software applications knows as the identity of the user. For example, the user, another user, or a technician does not know the identity of the user when the code or number is presented to that individual. If the credentials do not match, the user (or electronic device) is prevented from accessing the evaluation software application 105 and other software application and an invalid message is transmitted to the user.

Similarly, the authentication system 125 may control access to the evaluation software application 105 by other unregistered users (e.g., non-employee users), via a second electronic device. For example, the evaluation software application may provide the token to the second electronic device for allowing access to unregistered users for the purpose of providing evaluations for an evaluatee when such unregistered users are selected by the evaluatee as an evaluator.

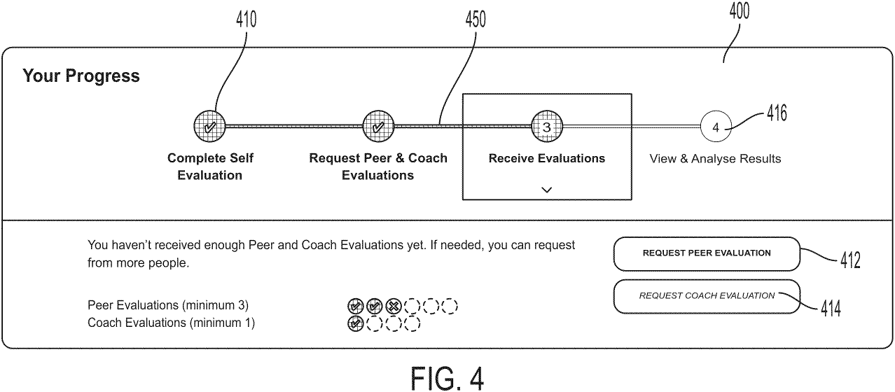

Once access to the evaluation software application 105 is granted to an evaluatee, the evaluation software application 105 provides user interface(s) (e.g., on the first electronic device 101(a)) that allow the evaluatee to perform several functions such as, request evaluations from peers or coaches, complete self-evaluations, view evaluation progress, view evaluation results, work on development of skills or training, or the like. For example, FIG. 4 illustrates a part of a user interface 400 that allows an evaluatee user to select an option to proceed to, for example, a self-evaluation user interface (using command 410), an evaluator selection user interface (using command 412 or 414), view evaluation results (using command 416), or the like. As shown in FIG. 4, the user interface may be configured to be shown as a progress bar 450 that illustrates the evaluatee’s progress during an evaluation process. A command may be a button (physical or digital button), an icon, a tab, a window, or the like permitting users to activate a functionality of a software application or a computer system.

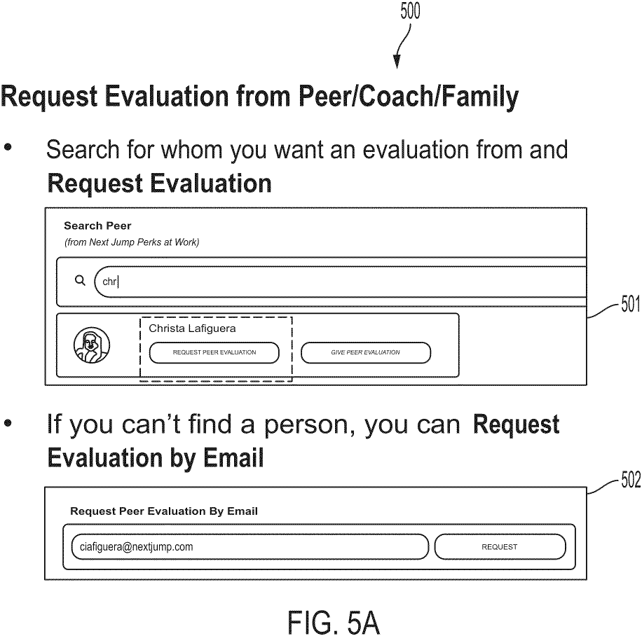

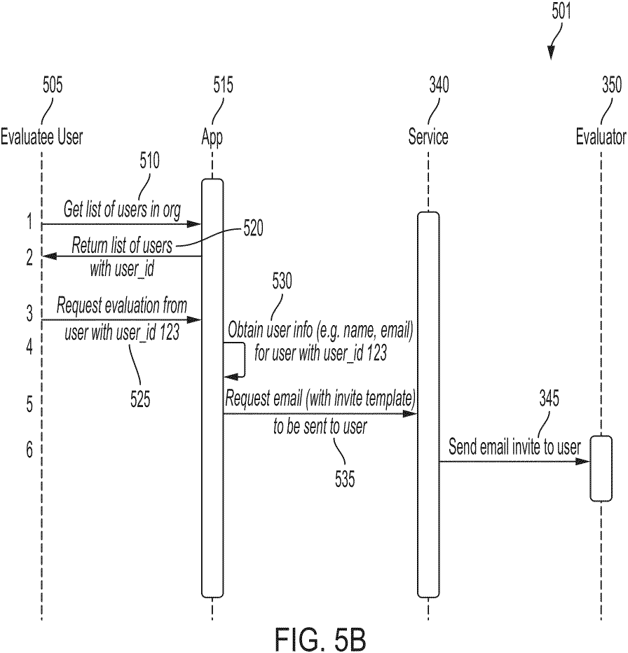

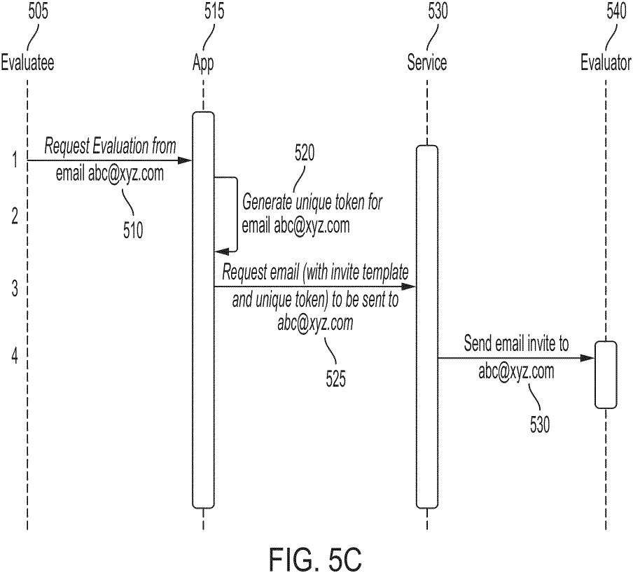

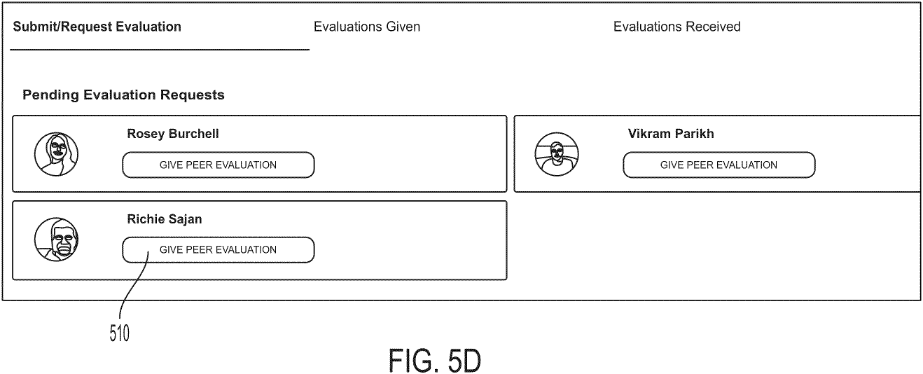

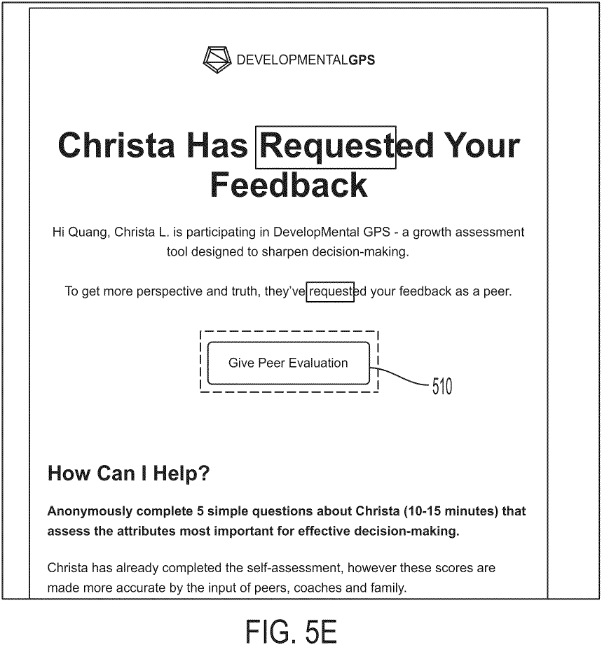

FIG. 5A illustrates part of a first user interface 500 that allows an evaluatee to solicit evaluations from peers or coaches by either searching for an evaluator who is already a registered user from a list of registered users (501) or by providing an email address for an evaluator (502). This screen may be displayed in response to the evaluatee user clicking on the evaluator selection command (412 in FIG. 4). The list of registered users may be employees of a company (the same company). FIGS. 5B and 5C illustrate a flow processeses 501 and 502 showing a communication between the evaluation software application and the second electronic device 101(b) for soliciting evaluations from registered and unregistered users, respectively. FIG. 5A shows how an evaluatee user 505 requests a list of registered users 510 (e.g., in an organization) from the user interface of evaluation software application 515. In response, the evaluation software application sends the list of registered users 520 (e.g., from an associated database) to the evaluatee user, and receives a selection of an evaluator 525 from the evaluatee user. The evaluation software application 515 is configured to communicate with an employee database (FIG. 1, 112) and obtain employee identity information from the employee database. The evaluation software application 515 can display all employees of the company (irrespective of rank, title, or role) or a limited set of employees such as employees determined to be employed at the same location, employees that are part of the same department, employees that are part of the same subgroup (or set) as that of the evaluatee, supervisors of the evaluatee, or the like. The evaluation software application then utilizes the evaluator user identifier to retrieve more information 530 (e.g., name, email, etc.) about the selected evaluator. The information 530 may be retrieved from a database that stores information about previously registered users. Specifically, employee identity information may include names of employees and an identifier for each employee to be used by the system for making a message available to the appropriate person. For example, upon selecting “Michael” from employee list, the evaluation software application determines that “Michael” is associated with identifier “0020” and presents the message to identifier “0020” so that Michael can view the message. The identifier may be an internal identifier used by the system and employee database to identify an employee. This identifier may be referred to as a recipient identifier. An update to the employee database also updates the employee list in option 520 accordingly. The evaluation software application may then send a message 535 including an evaluation invite template to a message transmission service 340 (e.g., an email service) for transmission to the selected evaluator 350. The evaluation invite may include, for example, an identification of the evaluatee user, information relating to how the evaluator may submit an evaluation (e.g., by accessing the evaluation software application), or the like. Such an evaluation invite may automatically be associated with the evaluator’s account with the evaluation software application. Specifically, in some embodiments, employees on the list are also individuals who have access to the evaluation software application. If the employee has not installed the application on an electronic device using his sign-in credentials, then the message sent to him is saved on the electronic message processing system and the employee can view it after he installs the application. In embodiments, the list may not show individuals who have not yet installed the application (only those who have the application installed are shown).

For clarification, in FIG. 1, for example, the application is illustrated as a mobile application, but the figures can also be illustrative of a web server implementation by having a web server implemented as part of the application environment and running the service application. The evaluation application can be configured to be implemented as a software as a cloud type application on a browser on the mobile phone or other type of device. The application provided by the web server is provided over a communication network, which can include the Internet. Other web or types of implementations are contemplated.

For example, FIG. 5D shows a part of an example user interface of a registered evaluator’s evaluation software application illustrating the solicited evaluations as pending evaluation requests 510.

FIG. 5C shows how an evaluatee user 505 requests an evaluation 510 from an unregistered user via the user interface of evaluation software application 515. For example, the evaluatee user 505 may provide an email address of the unregistered user. In response, the evaluation software application generates a secure unique token 520 for the received email address, and then sends a message 525 including an evaluation invite template and the generated token to a message transmission service 330 (e.g., an email service) for transmission to the selected evaluator 340. The evaluation invite template may include, for example, an identification of the evaluatee user, information relating to how the evaluator may submit an evaluation (e.g., a URL link to access the evaluation software application), login credentials (e.g., based on the generated unique token), or the like. For example, FIG. 5E shows a part of an example user interface of an unregistered user’s invitation to provide an evaluation that includes an embedded link 510 to access the evaluation form, without having access to the evaluation software application itself.

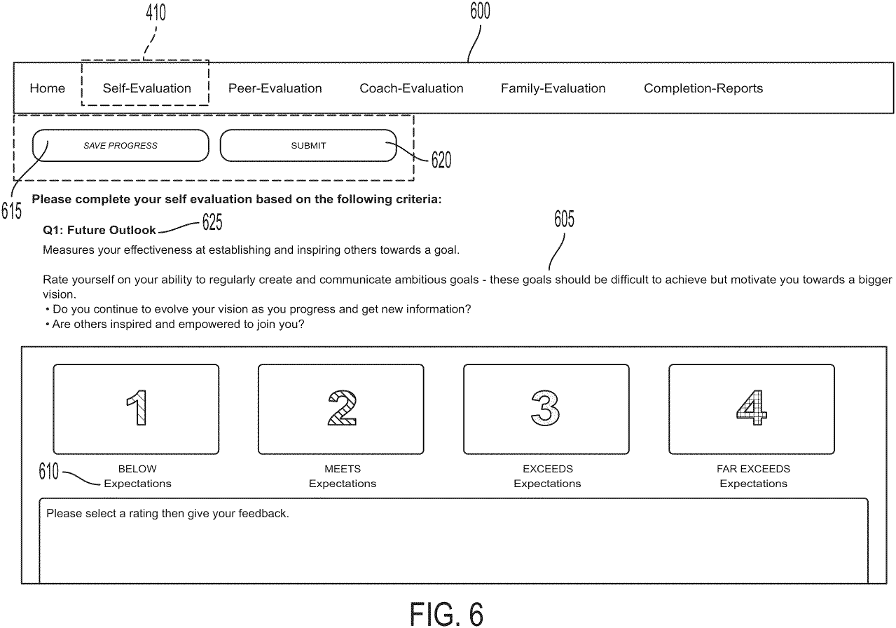

FIG. 6 illustrates part of the user interface of the evaluation software application that allows the user to complete self-evaluations. As an example, the evaluatee user may click on the self-evaluation command 410 to access a self-evaluation form user interface. FIG. 6 illustrates part of the user interface of the evaluation software application that allows the user to create and submit a self-evaluation. The self-evaluation creation area 600 includes, for one or more evaluation criteria or attributes (e.g., “future outlook” 625 shown in FIG. 6), a freestyle message composing area 605 allowing the user to compose evaluation message with their own words, a multi-level rating scale 610 allowing the user to select a numerical evaluation rating, a save command 615 for saving an incomplete self-evaluation draft, and a submit command 620 for submitting a complete self-evaluation for transmission to another computing device and/or for local storage. Optionally, a separate self-evaluation creation area may be successively displayed for each evaluation criterion until completion of self-evaluation by the evaluatee user for each evaluation criterion. An evaluatee user may also access his/her past self-evaluations. In various embodiments, if the user completes only one or two of the three fields, and/or does not complete all the fields of all the available evaluation criteria then the submit command 620 may be disabled and the user will not be able to submit the self-evaluation. Preferably only five or a small set (such as 4-6) of attributes is used and the specific attributes are those specified. The time the self-evaluation is created (i.e., when the user selects the send option 620) is also recorded by the evaluation software application.

The freestyle text area is an area where the user can enter a message by typing on a QWERTY keyboard of the electronic device with his own words. The user may also enter such a message in other manners, such as by speaking to or using gestures to convey his own words to the electronic device. The message the user enters is what is transmitted to the evaluation processing software application. The user’s ability to enter his desired words is not restricted or limited by the evaluation software application (e.g., when being forced to select only a certain options or predetermined messages), and the user can enter any words he wishes. Optionally, the freestyle text area may be associated with a maximum allowed message length. The numerical evaluation rating, for example, may be built as a scale of 1-4 with 1 being below expectations, 2 being meets expectations, 3 being exceeds expectations, and 4 being greatly exceeds expectations. Multi-level and types of rating scales are also contemplated. In some aspects, the evaluations are configured to be short by design such as only having the numerical rating of a small set of elvaluations and the text evaluation (limited in size) with little or no other questions or prompts (little could refer to one question) required for the evaluation to proceed without error.

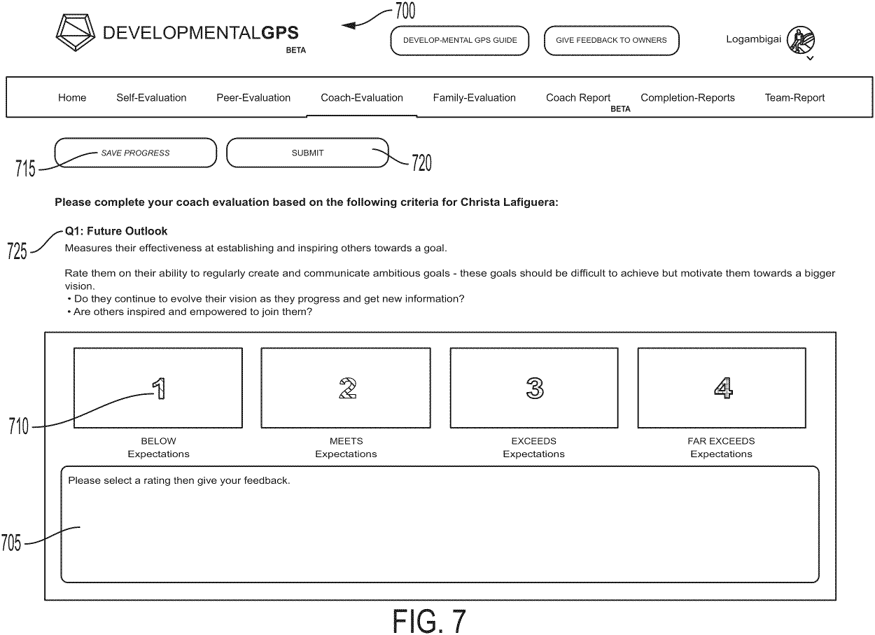

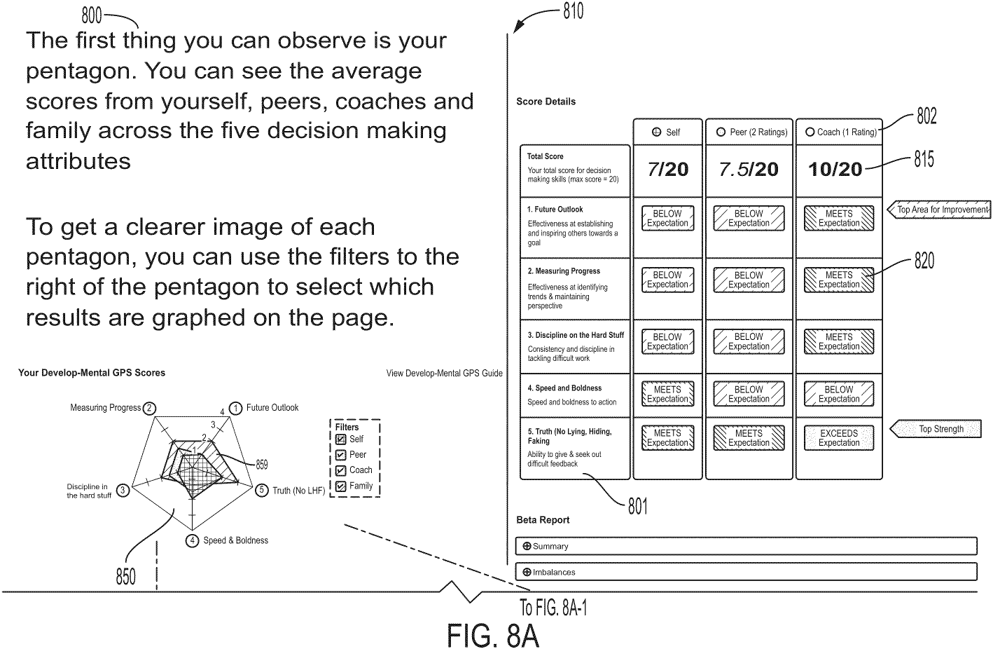

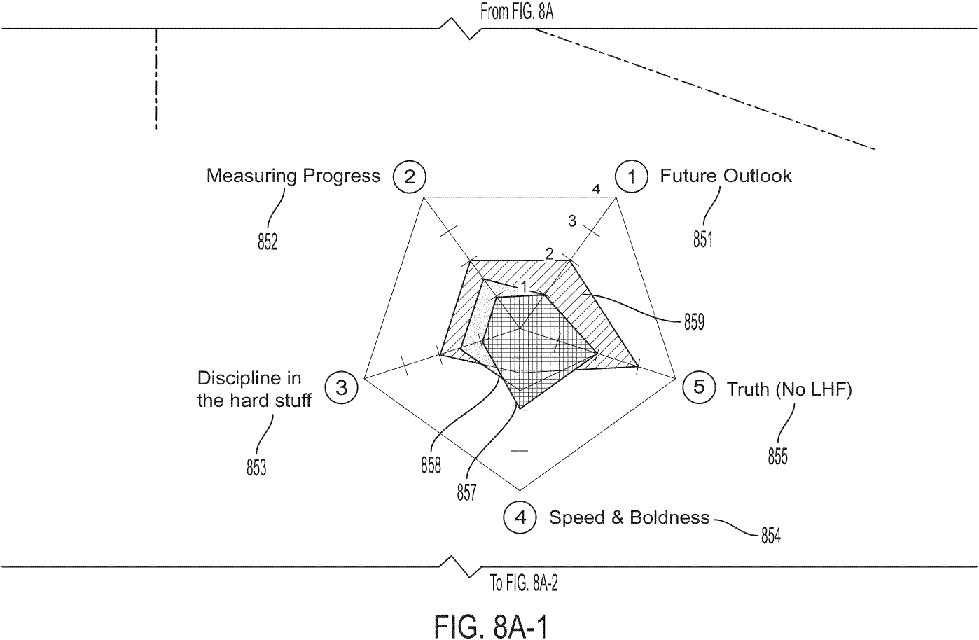

FIG. 7 illustrates part of the user interface of the evaluation software application that allows an evaluator to complete peer or coach evaluations. As an example, the evaluator (peer or coach) may access the user interface 700 upon clicking a URL link included in the email received with the invite for providing an evaluation (for unregistered evaluators) or by accessing the evaluation software application (for registered evaluators). FIG. 7 illustrates part of the user interface of the evaluation software application that allows the evaluator to create and submit a peer/coach evaluation. Similar to FIG. 6, the evaluation creation area 700 includes, for one or more evaluation criteria (e.g., “future outlook” 725 shown in FIG. 7), a freestyle message composing area 705 allowing the user to compose evaluation message with their own words, a multi-level rating scale 710 allowing the user to select a numerical evaluation rating, a save command 715 for saving an incomplete evaluation draft, and a submit command 720 for submitting a complete evaluation for transmission to another computing device and/or for local storage. Optionally, a separate evaluation creation area may be successively displayed for each evaluation criterion until completion of evaluation by the evaluator for each evaluation criterion. In various embodiments, if the evaluator completes only one or two of the three fields, and/or does not complete all the fields of all the available evaluation criteria, then the submit command 720 may be disabled and the user will not be able to submit the evaluation. The time the evaluation is created (i.e., when the user selects the send option 720) is also recorded by the evaluation software application. The system can be configured to have the peer and coach evaluations process be the same to provide comparative references (i.e., having the same attribute, numerical ratings, and/or free text areas). Optionally, the self-evaluation may be the same but without the text input.

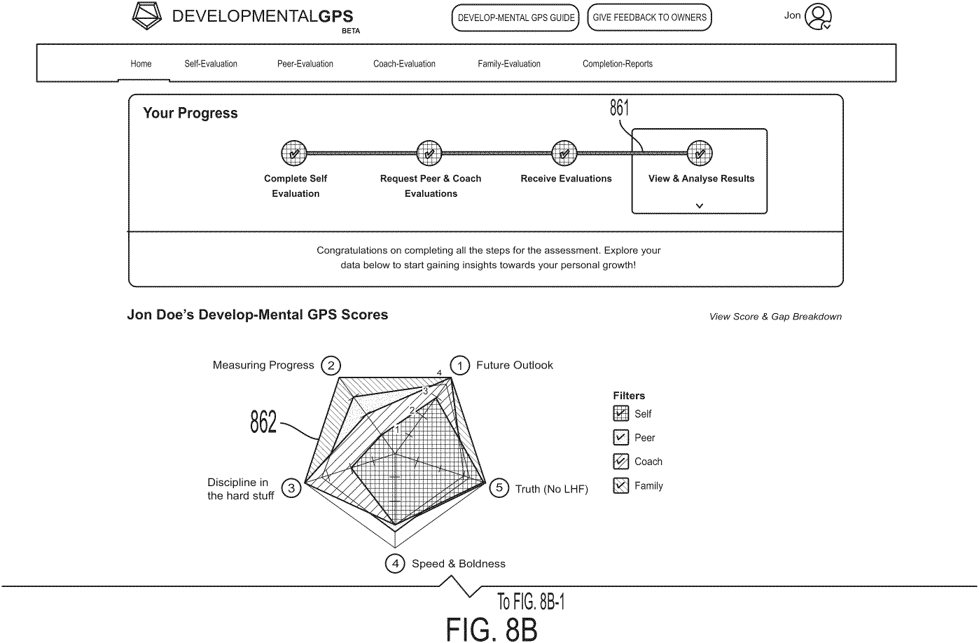

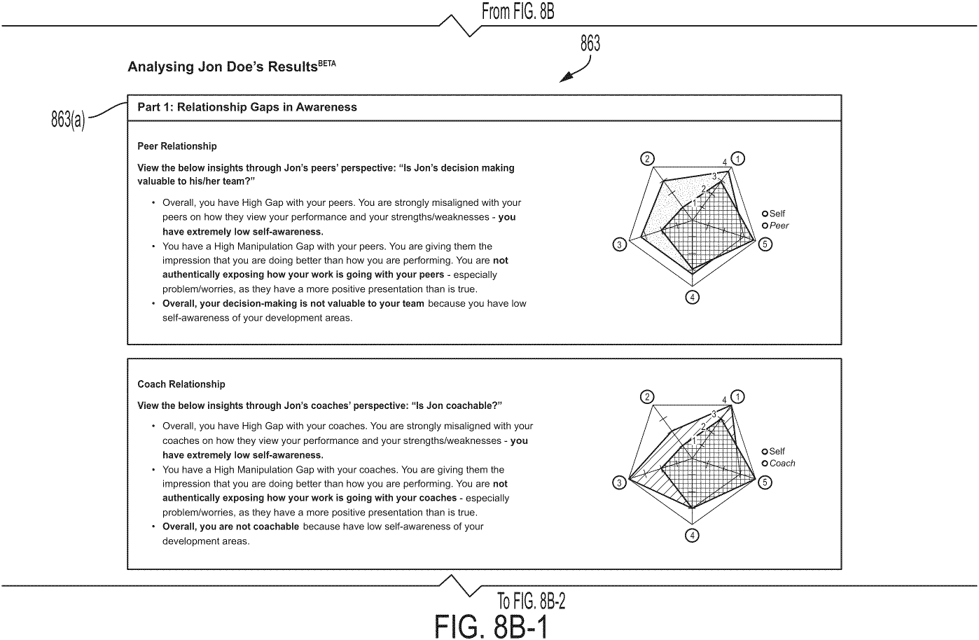

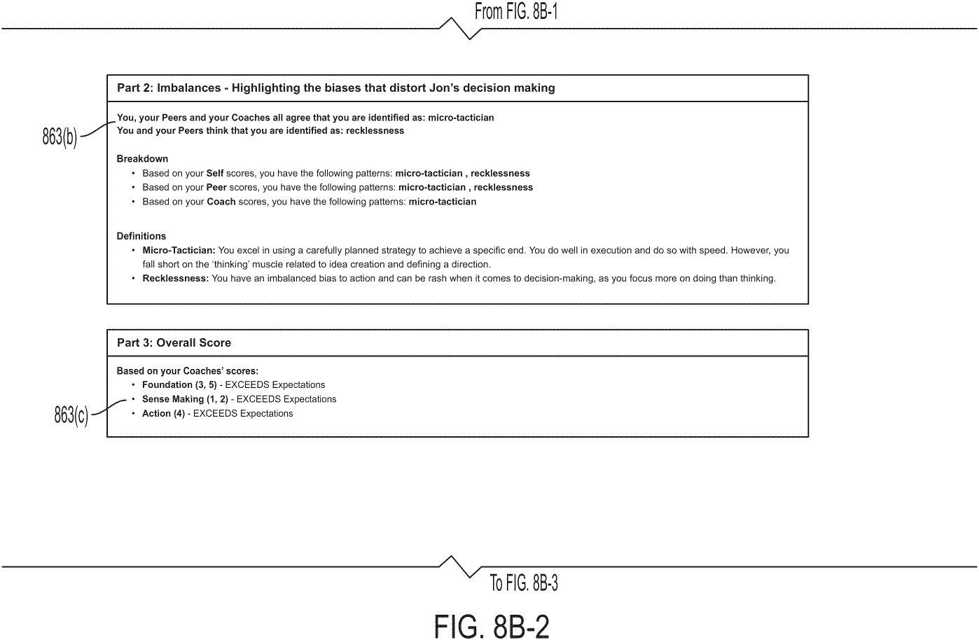

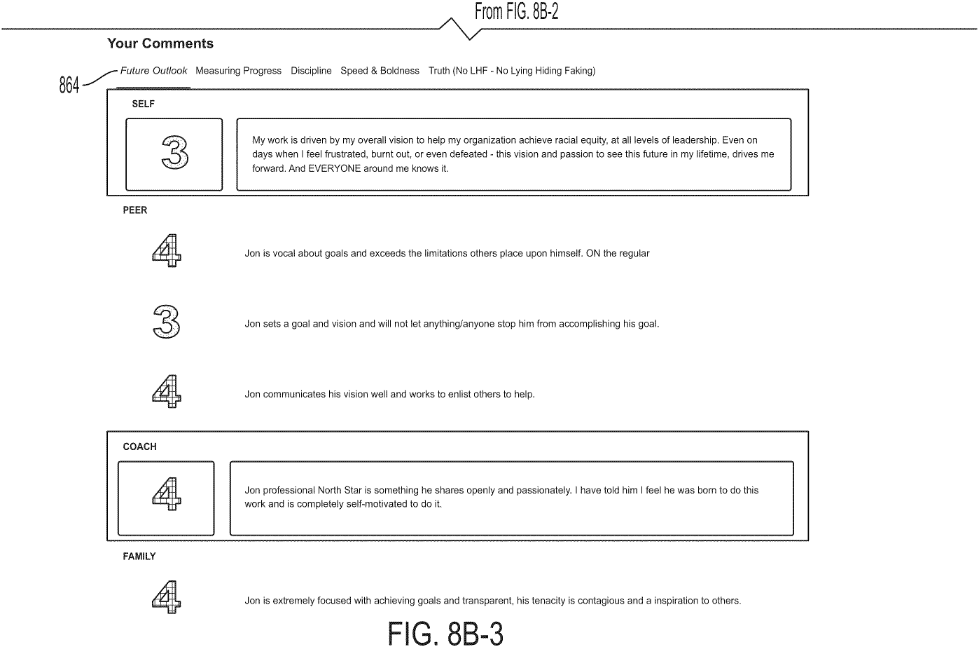

FIG. 8A illustrates part of the user interface to allow an evaluatee user to view submitted evaluations and corresponding evaluation analytics. As an example, the evaluatee user may click on the view evaluations 416 command (of FIG. 4) to access a user interface for viewing evaluations (free form and numerical evaluation ratings, and corresponding analytics). The user interface 800 shows the evaluatee identifier 810, the average score he has received in each evaluation type (802: self/peer/coach) 815, and an overview 820 of the evaluations he has received per evaluation criterion (801) in each evaluation type. The evaluation software application also provides an option that can be selected to view each submitted evaluation in detail. A graphical output (e.g., a radar chart) 850 is also displayed and discussed below in the more detail. Other information such as identified behavior patterns or behaviors, associated descriptions, suggestions for trainings or skill development, and/or links to trainings may also be included in the user interface. The user interface 800 is interactive and allows the evaluatee to filter, condense, expand (e.g., by hovering over), change the information included in the graphical output, or otherwise manipulate the displayed information.

In various embodiments, if the self-evaluation and/or the solicited evaluations are not complete, then the submit command view evaluations 416 may be disabled and the user will not be able to view the user interface of FIG. 8A. Only the evaluatee can view the completed evaluations and corresponding evaluation analytics; none of the other users or employees using the evaluation software application can access the same (e.g., the evaluations and corresponding evaluation analytics are available on the evaluatee evaluation software application only as a private space). Optionally, an evaluatee may invite or authorize a coach to view at least part of his or her private space in order for the evaluatee to work with the coach in reviewing his or evaluations and to generate plans (e.g., training) _for self-development. This can be implemented by having the coach being provided access to the data by way of the application displaying the information to the coach in his or her interactive space generated by the application. The evaluatee can only view the evaluations from the evaluation software application installed on his electronic device, into which he needs to login (see login and authentication processes described above) if he is not already logged in or has been logged out in order to use the application.

FIG. 8B illustrates a detailed report including sections such as, without limitation, the evaluation progress bar 861, overall scores as a radar chart 862, analysis reports 863 (including sub-parts such as 863(a), 863(b), and 863(c)), and an evaluation viewing section 864 that allows the user to view ratings and free text evaluations consolidated with respect to each of the attributes. These are described in more detail below. It is highlighted that the system is configured to perform certain processing and in response generate the report in a certain structure. In particular, subparts 863(a), (b), and (c) are configured to report on the corresponding groups of algorithms. In the first group, which in this example is relationship gaps in awareness, the group of algorithms are configured to analyze gaps between the data between self and peers and self and coach. This can be a geometric area type algorithm to determine geometric or area differences. The system reports on the identified classification and generates information that is displayed that corresponds to the specific classification. The second group, imbalances, corresponds to using algorithms that are configured to evaluate each of the self, peer, and coach generated data and identify data pattern classification for each. The third group corresponds to an overall score and the algorithm is configured to generate an overall score. As shown in the example, there are scores that are generated from the five number ratings by the coach that are determined by way of grouping and averaging. This structure can further benefit the user’s process.

In various embodiments, the displayed evaluations may be anonymized such that the evaluatee is not provided identifying information relating to the evaluator associated with each of the individual evaluations, using the methods discussed below. Optionally, peer and/or family evaluations may be anonymized while coach evaluations are not anonymized. A trusted anonymous feature is implemented.

The evaluation software application 105 is configured to generate an evaluator identifier identifying the evaluator, and a message identifier identifying the composed evaluation message, and, optionally, a time identifier (time information) identifying when the evaluation is sent (e.g., date and time), and an evaluation type identifier (e.g., peer evaluation, coach evaluation, self-evaluation, etc.). The system may also identify the evaluatee associated with the evaluation and create an evaluatee identifier. For example, the evaluatee may be identified using a token associated with the evaluation and that was sent with the evaluation invite to the evaluator (e.g., see FIGS. 5B and 5C). These identifiers may be generated in response to the evaluator user selecting the submit command (after the evaluator user completes an evaluation message and chooses a numerical evaluation rating) for an evaluatee. The evaluation software application 105 transmits the evaluation (including the evaluation message and rating) and the generated identifiers to another computer system (e.g., the servers on which the evaluation processing software application 110 is implemented) over a network via the network connection interface of the electronic device 100 after the user selects the send command.

With respect to the evaluation processing software application 110, the servers on which the evaluation processing software application 110 are implemented are configured to receive the evaluation and the generated identifiers over the network via the network connection interface of the servers. The evaluation processing software application 110 also checks if an authorization token exists and verifies whether the token is valid, for determining the identity of the evaluatee, associating the received evaluations with the evaluatee, and/or to verify that the evaluation was solicited by the evaluatee. The evaluation processing software application 110 includes two environments, an application environment 130 and a reporting environment 135. The received data and the token enter from the application environment 130.

In some implementation, the anonymous aspect can be implemented with one database such as the first database 145 and software process can be used as a software module and/or authorization information in table can be stored to limit the information that is provided in the peer evaluation report to maintain anonymity. In others, additional or alternative anonymity features can be implemented.

In one embodiment, the application environment 130 includes a service (or service application) 140 that processes the received data, a first (primary) database 145 for storing the received data, a data cache and retrieval system 150 for storing a portion of the received data, and a second database 155 for storing a portion of the received data. Upon receiving the data, the service 140 stores the received data in the first database 145. The service 140 may store the entire received data in the first database 145, namely, the evaluation and the generated identifiers. In other words, the service 140 stores what is received by the application environment 130 in the first database 145. In some embodiments, the service 140 stores at least the evaluation (evaluation message and rating), the evaluator identifier, the evaluation type identifier and the evaluatee identifier in the first database. Other combinations are also contemplated. The data stored in the first database is raw data, meaning that the data received is the same as the data stored or that there is no additional procedure applied to remove, add, or modify (e.g., encrypt) any data in the received data other than those basic or inherent in the operations of the software application and the servers, such as decoding, analogue-to-digital conversion, etc.

The service 140 also duplicates the received data, removes or erases the evaluator identifier from the duplicated data, and stores the remaining data in the duplicated data (or the duplicated data without the identifier) in the data cache and retrieval system 150. The service 140 may duplicate the received data as the data is received or from the data in the first database 145. The data 150 in the data cache and retrieval system 150 is devoid of evaluator identifiers, optionally including the evaluation type identifiers. The data 150 in the data cache and retrieval system 150 can be retrieved using the evaluatee identifier by an evaluatee (i.e., the evaluatee’s evaluations and ratings), and only upon authentication of the evaluatee.

Additionally, the evaluator identifier in the first database 145 may be duplicated and stored in the second database 155. The second database 155 is not linked to the data cache and retrieval system 150). The database 155 and the system 150 are two separate, independent systems. The duplication can be achieved through an asynchronous job. The evaluator identifier in the second database 155 may be further encrypted. The time information in the first database 145 may be also duplicated, diluted, and stored in the second database 155. For example, the time information may show the exact date and time the evaluation was sent, such as on May 2, 2018 at 2:00 pm. This information may be generalized or downgraded (e.g., to a lower resolution in time) such that the modified time information only indicates that the evaluation was sent on May 2, 2018, in the first week of May in 2018, or in May 2018. The time information may be modified by eliminating the time portion (e.g., 2:00 pm) only, by eliminating the time portion and changing the date portion to a lower resolution (e.g., from May 2 to first week in May), or by changing the time portion to a lower resolution (e.g., from 2:00 pm to afternoon) and the date portion to a lower resolution. Similarly, the evaluation type may be eliminated to obtain lower resolution. Higher resolution in time means that the time information is more specific whereas lower resolution in time means that the time information is less specific. Similarly, the evaluation type identifiers may be eliminated to obtain lower resolution. Higher resolution in evaluation type means that the evaluation type information is more specific whereas lower resolution in evaluation type means that the evaluation type information is less specific. Encryption and dilution are used to anonymize evaluator’s identity. Duplication, encryption, and dilution may be performed under instructions given by the service 140. The time/evaluation type information in the system 150 is saved in original time resolution.

For clarification, the processes performed by the service 140 refers to one or more of the aforementioned storing step (with respect to the first database 145), duplication step, removal step, and storing step (with respect to the data cache and retrieval system 150). They may further include the step of duplicating and storing the evaluator identifier in the second database 155.

The reporting environment 135 accesses the data in the data cache and retrieval system 150 to perform an evaluation analysis.

Alternative to removing the evaluator identifier from the raw data before saving to the data cache and retrieval system 150, the evaluation processing software application 110 can be implemented with asymmetric encryption. In this embodiment, the application environment 130 is equipped with a public key configured to encrypt the evaluator identifier. The applicant environment 130 can encrypt the evaluator identifier of each evaluation sent by the same person differently (e.g., with a different code), but know that the different codes are associated with the same evaluator identifier or person. For example, the applicant environment 130 can encrypt the evaluator identifier of evaluation message A with XXXX and the evaluator identifier of evaluation message B with YYYY when both evaluation messages are sent by the same person. After encryption, the encrypted evaluator identifier and the other data (e.g., evaluation message, rating, and other identifiers) are stored to the data cache and retrieval system 150. The reporting environment 135 accesses the data in the data cache and retrieval system 150 and uses it to perform evaluation analysis. The reporting environment 135 is equipped with a private key to decrypt the encrypted evaluator identifier so it can perform an evaluation analysis to the user corresponding to that identifier or provide a sentiment analysis to that user. The encrypted evaluator identifier can only be decrypted using the private key.

Each environment and service may be referred to as a system or subsystem within the evaluation processing software application.

The identifier removal embodiment or asymmetric encryption, the data in the first database 145 and the data cache and retrieval system 150 may be stored as tables. The received data can be transformed into different data structures such as tables by the service 140 before it is saved, or by the database 145 or the data cache and retrieval system 150 after the service 140 provides the data. For example, the service 140 (or the first database 145/the data cache and retrieval system 150) can create tables by separating the evaluation message, identifiers, and rating into at least two categories and stores each category as a table. The evaluation message, evaluation type identifier, evaluatee identifier, message identifier, and rating may be classified in one category and saved in one table, and the evaluator identifier may be classified in a separate category and saved in another table. The two-table format is saved in the first database and the data cache and retrieval system. As discussed above, the evaluator identifier can be removed or encrypted before being saved to the data cache and retrieval system. As such, the two tables in the first database includes the evaluator identifier and the two tables in the data cache and retrieval system either is devoid of the evaluator identifier or has the evaluator identifier encrypted. The reporting environment 135 may access the data in the two-table format. The evaluator identifier in the second database 155 may be duplicated from the data in the two-table format in the first database 145.

The data cache and retrieval system 150 is used by the service 140 to retrieve the necessary data in response to a request sent by the evaluation software application 105 (e.g., an evaluatee using the evaluation software application 105 upon authentication of the evaluatee login credentials). The data cache and retrieval system 150 is used by the service 140 to keep evaluator’s identity anonymous since the evaluator identifier is either unavailable or encrypted. Evaluator identifier in the second database 155 is used or encrypted evaluator identifier is unencrypted only in limited circumstances by the reporting environment 135 when analytics requires it. Furthermore, the data cache and retrieval system 150 is used by the service 140 such that an evaluatee can only access his evaluations and ratings, without the evaluator identifier.

The data cache and retrieval system 150 (or the retrieval system for simplicity) is a system that includes a cache mechanism, an index mechanism, and a database. The cache mechanism may be based on Redis or memcached technology and is used to cache the data in the retrieval system 150, in particular the data that has been previously found or retrieved. For example, when the service 140 queries a database in response to a request sent by the evaluation software application 105 and the retrieval system 150 returns the results, the results are stored in the cache for a period of time so the results can be quickly accessed when they are called (e.g., can be retrieved in several milliseconds, instead of several seconds). The index mechanism search indexes the data in the retrieval system 150 and saves the indices in the index mechanism. The index mechanism enables quick searching for the data in the retrieval system 150. The data searched by the index mechanism may be either data that has not been searched before, or data that has been stored beyond the period of time allowed by the cache and is cleared from the cache. The index mechanism may be the default mechanism used by the retrieval system 150 to search data and the cache mechanism may be used by the retrieval system 150 if the data to be searched is already in the cache mechanism. As to the database, the cache mechanism and the index mechanism operate on the data in that database to retrieve the necessary data. For example, the index mechanism may inverse-index each evaluation message and rating in that database. When a search is conducted, such as by the reporting environment 135 or the evaluation software application 105 for evaluation type in the evaluation messages stored in the retrieval system 150, the index format allows the environment 135 or software application 105 to quickly identify and retrieve those messages. Other techniques and platforms related to searching are contemplated.

The retrieval system 150 also includes two security measures or configurations to protect the identity of an evaluator as well as the evaluation information of an evaluatee. One security measure is that the evaluator identifier is used by the retrieval system 150 to find evaluation messages and ratings stored in the retrieval system 150 that the evaluator has given. That identifier only allows that particular user (through his evaluation software application and the retrieval system) to look up the evaluation he has given. The user (and the evaluation software application and the retrieval system) cannot use it for other purposes, such as to look up evaluations other people have given for the evaluatee or identities of other evaluators and their evaluations (except when the user is the evaluatee himself). Similarly, the evaluatee identifier is used by the retrieval system 150 to find evaluation messages and ratings stored in the retrieval system 150 corresponding to the evaluatee. That identifier only allows that particular user (through his evaluation software application and the retrieval system) to look up the evaluations (without evaluator identifiers - i.e., anonymously) he has received. The user (and the evaluation software application and the retrieval system) cannot use it for other purposes, such as to look up evaluations other people have given for other evaluatees or identities of the evaluators. Another security measure is that the retrieval system 150 provides public key-private key cryptography or is configured to work with a system implemented with such cryptography. When a system is without asymmetric cryptography, the retrieval system 150 can provide such functionality and the system can operate as described above (the alternative embodiment). When a system already has this feature, the encrypted evaluator identifier is indexed by the retrieval system and used to anonymously and quickly find evaluation (that is also indexed) the individual of that identifier has given.

The data cache and retrieval system 150 may be referred to as an enterprise search and index engine that is capable of retrieving information from many different databases, including the database in the system 150 and other databases. The system 150 provides quicker and more responsive capabilities in the context of the evaluation system. For example, the user interface of the system simplifies the evaluation information to be saved and the system 150 can quickly index, save, search, and retrieve data because of the simplified structure. In systems other than evaluation systems or evaluation systems that do not provide a simple user interface, the amount of information received, e.g., from a Word or PDF document, may be significant such that using system 150 may not be as quick and efficient in indexing, saving, searching, and/or retrieving data.

The first database 145 storing the raw data or all the received data (including the evaluator identifier) is built with security measures or configuration to prevent unauthorized access. The first database 145 may be implemented in another private network and sit behind a firewall that is different from the private network and firewall in which the evaluation processing software application (excluding the first database 145) is implemented. For example, accessing the first database 145 may require a different login process or credentials from those of the evaluation software application (a separate portal). The first database 145 may be known as a production database server. The security measures or configuration can be implemented in two levels, application level and database level.

In one embodiment, the first database 145 is highly restricted such that only a certain software and service application can access the first database 145 (application level). The first database 145 is also highly restricted such that only a certain individual who has complete access to the first database 145 or who has at least the access to the evaluator identifiers in the first database 145 can access the first database 145 (database level). On the application level, the first database 145 may grant permission to the evaluation software application 105 and the service application 140 (and only those applications) allowing them to write into and read from the first database 145. The evaluation software application 105 and the service application 140 may be configured such that they write data into the first database 145 and read data from the data cache and retrieval system 150. On the database level, only the first database creator and individuals approved by the first database creator have access. The creator and authorized applications and people can view or retrieve the raw data, including the evaluator identifier and the actual evaluation, from the first database 145. The raw data is not encrypted. The creator and allowed individuals access the first database 145 through a two-step security process. First, they are required to log into the private network on which the first database is situated that is different from the private network on which the evaluation processing software application (excluding the first database) is situated. Second, their credentials are checked by the first database 145 whether they have permission to access the data in the first database 145 if they want to access that data. In some embodiments, the second step may involve submitting another login credential that is different from the first step. Both are privileged access and require permission from the creator. Only individuals who pass both steps can access or view the raw data in the first database 145. Some individuals may be granted with only the first privilege access so that those individuals can modify or update the hardware and software of the first database 145 or work on the first database 145 for other purposes such as testing and network related issues. Those individuals, however, do not have access to the raw data in the first database 145.

A database management software application 160 is implemented to interact with the first database 145. The database management software application 160 may be accessible only by the first database creator. The database management software application 160 provides a user interface allowing the first database creator to grant first database access permission to software applications (e.g., evaluation and service applications 105, 140) and individuals (e.g. users who are granted with the first privilege access and users who are granted with the second privilege access). Users who are granted with the second privilege access means users who are granted with the first and second privilege access.

A user access log system 165 (or software application) is also implemented to interact with the first database 145. The log system 165 may be part of the first database 145 or the evaluation processing software application 110. The log system 165 is configured to record every authorized user’s access to the first database 145, including the first database creator’s activities. The log system 165 can record activities that happen under the first privilege access and the second privilege access. For example, activities that occurred under the first privilege access may include the identity of the authorized user, the hardware, software, data, and network the authorized user modified, the date and time of authorized user’s actions, and other information. Activities that occurred under the second privilege access may include the identity of the authorized user, the raw data the authorized user accessed, such as evaluator identifiers and actual evaluations, corresponding evaluatee identifiers, the date and time of user’s actions, and other information. The log system 165 is configured by the first database creator or other professionals (e.g., technicians, engineers, network administrators, IT specialists, etc.) to be accessible by a limited number of users so that they can check if anyone (including the creator) has accessed the data in the first database 145. Since the system is configured to keep evaluator’s identify anonymous, the log system 165 is designed to check if there is any human access to the data in the first database 145 that may compromise an evaluator’s identity, compromise evaluation information, etc. when authorized individuals are not supposed to access this information.

Another embodiment of the security measures or configuration for the first database 145 can also be implemented. The second embodiment is also implemented in the application level and the database level. On the application level, it involves two entities, software application and service application, and application administrators. Software application and service application (or one of the applications) are provided with a security key or hash that enables them to encrypt an evaluation and to access the first database 145 (e.g., storing the encrypted evaluation in the first database and retrieving the encrypted evaluation from the first database) only for authorized users (e.g., the corresponding evaluatee). The same security key may also allow software application and service application to decrypt retrieved evaluation, or software application and service application may be provided with a second key to decrypt the data (such that the actual message and rating and the evaluator identifier can be seen or be otherwise available). Application administrators, e.g., professionals who manage or control the evaluation software application and service application, may also have the decryption key and may be the only individuals who have such a key. The first database 145 and database administrators (described below) do not have the decryption key and are unable to decipher the encryption.

On the database level, it also involves two entities, the first database and database administrators. The first database 145 is equipped with a security mechanism that can check whether a user trying to access the first database 145 has the necessary security key (the first database 145 itself may also have such a key). Database administrators, e.g. professionals who manage or control the first database 145, may be the only individuals who are provided with such a key. The security key for the first database is different from the encryption/decryption key in the application level. The software application and service application and application administrators (described above) do not have the security key for the first database 145 and are unable to access the first database 145.

Based on the above, accessing and decrypting the evaluation in the first database 145 such that the actual message, rating and evaluator identifier can be seen or be otherwise available requires both the decryption key and the first database’s security key. Both keys may be generated and provided to their respective administrators at the onset when the second embodiment of security measures or configuration is installed. A platform may be implemented with the second embodiment that allows the administrators to submit their keys. The administrators can access the data in the first database 145 and decrypt the data in the first database 145 from the platform. To further strengthen the security level of the second embodiment, application administrators and database administrators may be limited to individuals who hold the most senior positions (in terms of ranking) or executive-level positions in the organization, or those who can make executive decisions on behalf of the organization (e.g., Chief Executive Officer, Chief Financial Officer, and Chief Technology Officer). For example, the application administrator may be the CTO and be provided with the decryption key, whereas as the database administrator may be the CEO and be provided with the security key to the first database. Therefore, it requires both the CTO and CEO to submit their respective keys into the platform in order to access and decrypt the data in the first database (in order to see the actual evaluations and identities of the evaluation givers). As such, the first database creator may not have either key and is unable to access or decrypt the data in the first database 145 even though he designs and installs the first database and its technology (e.g., its security measures or configuration).

The second embodiment may be referred to as a foolproof security model with distributed security access (e.g., between application administrators and database administrators). Security measures or configuration based on the combination of the above two embodiments are also contemplated. Security measures or configuration based on the combination of one or more features in the first embodiment and one or more features in the second embodiment is also contemplated.

The evaluation software application 105 and the analytics software application 115 may not be able to access the first database 145. Both applications may be directed to the data cache and retrieval system 150 to obtain the necessary data.

Implementing the service, databases, data cache and retrieval system, and security measures discussed above allow the evaluation system to maintain evaluator’s identity anonymous while still being able to perform analytics on evaluations given by an evaluator in a limited, unexposed manner (without compromising evaluator’s identity). Embodiments of the disclosure ensure the highest level of access restriction and data protection, in particular to information identifying the evaluator, as well as only allowing an evaluatee to access his or her evaluations. The first database and related applications and systems built with the above features improve the operations or security operation of the first database. They may also improve the storing and organization of the received information in the evaluation processing software application in some embodiments.

However, such levels of security may not be implemented in some embodiments. For example, control over which data is accessible or shown to users can be controlled using the above-mentioned tables that specify the authority of the user and this can be without application level or database level security. It can also be without performing the more complex anonymization processes described, for example.

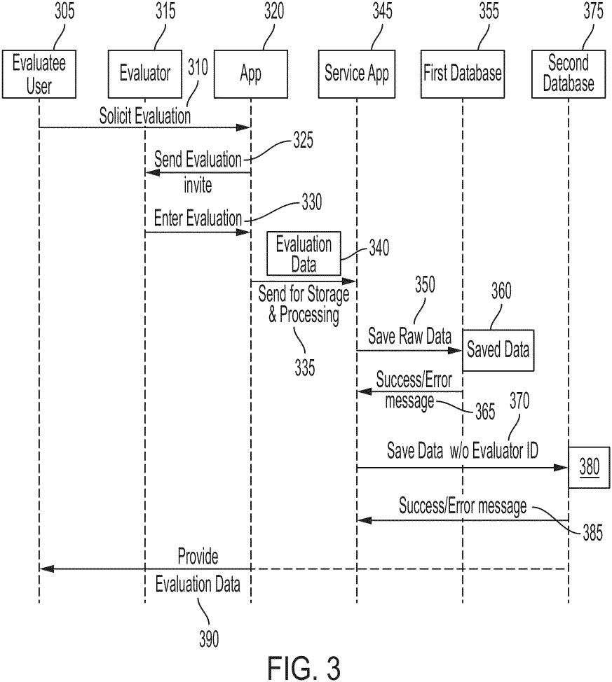

FIG. 3 illustrates a flow process 300 showing a communication between the evaluation software application and the evaluation processing software application. In particular, FIG. 3 shows how a submitted evaluation is saved in the application environment of the evaluation processing software application and how the submitted evaluation is provided to the evaluation software application. An evaluatee user 305 solicits an evaluation (310) from an evaluator (315) from the user interface of the evaluation software application 320, where the solicitation is associated with an evaluatee identification. The evaluation software application (320) sends an evaluation invite (325) to the evaluator (315) that is also associated with the evaluatee identification and, optionally, includes a token for unregistered users. The evaluator 315 enters a solicited evaluation 330 (including evaluation message and rating) from the user interface of the evaluation software application 320. In response to the evaluator selecting the send command, the evaluation software application sends a request or a request payload 335 containing the evaluation, evaluatee identifier, evaluation type identifier, and the evaluator identifier (collectively referred to as evaluation data 340) to the service application 345 of the application environment. The service application 345 then may save the evaluation data 340 or raw data in the first database 355 (step 350) in a suitable format as data 360. The first database 355 then responds with either a success or error message (step 365) to the service application 345 indicating whether the raw data is successfully or unsuccessfully saved, respectfully. The service application 345 may also duplicate the same raw data, remove the evaluator identifier from the duplicated data, and save the duplicated data without the evaluator identifier in the data cache and retrieval system 375 (step 370). The duplicated data without the evaluator identifier may be saved as 380. The data cache and retrieval system 375 then responds with either a success or error message (step 385) to the service application 345 indicating whether the duplicated data without the evaluator identifier is successfully or unsuccessfully saved, respectfully. Once the data without the identifier is successfully saved, the service application 345 provides that data, which is the data the user selected to send but without the evaluator identifier, to the evaluation software application (step 390). For example, the service application 345 may provide the data to the analytics system for analysis and/or the evaluation software application for display to the evaluatee user 305. The evaluation software application shows the evaluatee the evaluations he or she has received and the corresponding analysis, upon authentication. No other users are allowed access to the evaluatee’s evaluations or analysis. Specifically, the service application 345 determines the evaluatee identifier corresponding to the evaluatee and retrieves evaluation messages and ratings using the determined evaluatee identifier from the retrieval system, and provides the retrieved evaluation messages and averaged ratings to the evaluatee. The evaluation software application continually updates the data to show the latest evaluation (and the previous evaluation), e.g., the evaluation submitted in step 310, that the evaluatee has received. In some embodiments, the system is configured to use HTTP GET and HTTP POST messages to send and receive evaluation messages from the server.

It should be noted that while the above description describes keeping the evaluators identity as anonymous, the disclosure is not so limiting, and in some embodiments, the system may not use such anonymization features. For example, and evaluator may instruct the system to not keep his identity as anonymous and to share it with the evaluatee. In such examples, the system may use the raw data in the first database 145 directly for reporting and analytical purposes.

The evaluation may be an overall analysis (considering all the messages and numerical ratings), evaluation type-specific, or attribute-specific. The evaluation analytics software application includes computer algorithms and artificial intelligence that are programmed to perform the above operations. The evaluation analytics software application is also configured to identify an evaluatee’s characteristics using the received evaluation messages and numerical ratings. The evaluation analytics software application uses the data in the system 150 to make such determinations and evaluations. In some embodiments, the learning behavior identification process can also consider the user’s given evaluation. The evaluation analytics software application 110 uses the data in the system 150 so that the identities of the evaluators are kept anonymous. In some embodiments, however, the evaluation analytics software application 110 can further consider the data in the second database 155, if necessary.

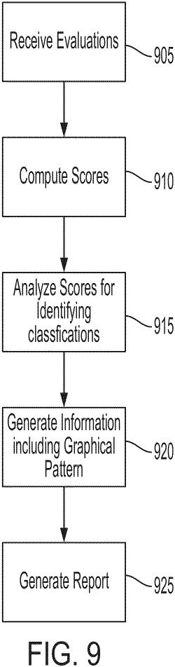

Referring now to FIG. 9, the flowchart describes a general flow chart involved in identifying and classifying multidimensional data patterns including attribute interrelationships (e.g., data relationships between pairs or groups of attributes including, for example, the further dimension of inter-evaluator relationships such as coach versus self) in accordance with embodiments of the present invention, and may be executed by the evaluation application and/or the evaluation processing software application in conjunction with a software engine and reporting component. For example, a system is implemented that stores a library of algorithms that each have a corresponding classification and related stored data when a classification or state is detected. Optionally, the software engine may be included in the analytics application 115 of FIG. 1. The software engine is configured to apply the library of algorithms (as a whole, individually, or in combination) such as by evaluating the numerical scores for each attribute and detecting whether one or more of the algorithms are completed/satisfied, e.g., detecting a classification. The algorithm can include many levels of complexity such as being able to detect interrelationships between certain attributes. For example, does the average of the first and third attribute result in a higher number than the score of the second attribute. Or for example, does the average of the first and third attribute result in a higher number than the score of the second attribute while the score for the second attribute is lower than each of both the fifth and fourth attributes. A complex analysis of many different patterns can be detected and classified from the automated data analysis based on a corresponding library of information. The classifications through the algorithm and the stored classification information can be used to display the detected classifications or other automated assessments to the user through a structured report that is displayed to the user in the application. The report can be displayed in conjunction with a radar chart that provides an interactive radar display. The classification and report process provides the same data to (all) users in the company when a classification is detected, and the classification is only provided (software limits access to the data) to the user’s private space and selected coach(es). By “the same” data, this is referring to the ability to report and display to each user the detected classification in the same way.

Referring back to FIG. 9, self-evaluation and peer/coach evaluations with respect to a plurality of attributes are received (905). As discussed, the self-evaluation and peer/coach evaluations include numerical ratings and freestyle text evaluations with respect to the attributes. As an example, the evaluations provide assessments relating to the following five factors or attributes: (1) future outlook (as a measure of effectiveness at establishing and inspiring others towards a goal); (2) measuring progress (as a measure of effectiveness at identifying trends and maintaining perspective); (3) discipline in the hard stuff (as a measure of consistency and discipline in tackling difficult work); (4) speed and boldness (as a measure of speed and boldness to action, which considers an individual’s ability to make trade-offs); and (5) truth - no lying, hiding or faking (as a measure of how authentically an individual communicates with others and his/her ability to seek out truth). The evaluation processing software application (e.g., the service application) is also configured to, for example, average numerical evaluation ratings per evaluation criteria (in each evaluation category - e.g., peer evaluations and coach evaluations) of the evaluatee, and provide the evaluation messages in each category and average numerical evaluation rating to the evaluatee, via the evaluation application software user interface (e.g., as shown in FIGS. 8A and 8B). The service application may access the evaluation messages and the ratings saved in the data cache and retrieval system to provide the evaluation messages and the average ratings to the evaluatee, upon request from the evaluatee. The identity of the evaluator of each evaluation message is kept anonymous, as discussed above.

The software engine then begins analyzing the evaluations (910) by generating one or more scores based on the received numerical ratings in the evaluations. For example and without limitation, the software engine may compute an overall attribute score received by the evaluatee (e.g., by adding all the numerical values of that attribute), an average attribute score received by the evaluatee (e.g., by averaging all the numerical values of that attribute), overall self, peer and/or coach scores (e.g., by adding scores in the self-evaluations, in the peer evaluations, and/or the coach evaluations), differences in the self-evaluation numerical values with respect to those provided by the peers and/or coaches (e.g., by averaging the numerical values of an attribute provided by the peers and/or coaches and determining the difference from that of the self-evaluation value for that attribute), average and/or overall scores with respect to combination of one or more attributes and/or comparison of such scores with other scores, or the like.

The software engine then performs multi-level classification and analysis of the evaluatee’s current behaviors based on the computed scores (915) by detecting detect interrelationships between certain attributes. For example, the software engine may analyze the evaluations and the and the computed scores to determine or detect certain patterns observed in the given evaluation messages and numerical evaluation ratings, and communicate a visual indicator based on the determined patterns to the evaluatee. In determining patterns, the evaluation analytics application 115 may parse the free style evaluation messages based on a large set of words and synonyms and/or determine additional scores based on the free style messages. The software may conduct an analysis of each of the scores (e.g., calculated score and/or additional scores) such as by traversing through the analysis point by point to identify classifications from the library. In the instance of self-evaluation directed to improving decision making attributes, the software engine may use the computed scores to classify the evaluatee’s imbalances and relationship gaps with peers and/or coaches. As to the overall score, the metric may classify the evaluatee’s decision making on a scale (e.g., average, exceed expectations, meets expectations, needs work, etc.) with respect to, for example, foundation, sense making, and action. The overall score may, optionally, only take into account numerical scores provided by coach evaluators with respect to various attributes, and classifies them under various traits and corresponding scale level. As to the imbalances, the determined metric may indicate or highlight biases that may distort an evaluatee’s decision making. As to the relationship gaps, the automated analysis may evaluate the gap between the evaluatee’s self-understanding with that of his peers and coaches. The metric may, for example, indicate that the user is silent when the user does not give any evaluation or does not receive enough evaluation (e.g., below a threshold). This can be also understood as an automated interpretation engine that is consistent for everyone in the company, which can be remotely updated, and is private to the user. It can also identify and classify by evaluating the scores (and/or other information in an evaluation) underlying indirect information that the system has knowledge of based on the library of algorithms.

In various embodiments, the relationship gap of an evaluatee with his peers is determined by comparing the self-evaluation numerical ratings with that of the average numerical ratings of peers, and the relationship gap of an evaluatee with his coach is determined by comparing the self-evaluation with that of the average numerical ratings of the coach(es) per evaluation criteria. For example, an average score per evaluation criteria of the peer evaluations is compared with the corresponding self-evaluation score for that criteria to determine a gap for that criteria. The gaps for each of the evaluation criteria are combined to determine an overall relationship gap in awareness. Such an overall relationship gap in awareness may be compared to one or more thresholds to, for example, determine if an evaluatee’s gap is high, moderate, low etc. with respect to his peers or coaches.

### EXAMPLE

Step 1

| e.g. | Peer Eval A: | 1, 1, 1, 1, 1 |
|---|---|---|
| | Peer Eval B: | 1, 1, 1, 1, 1 |
| | Average Peer Scorecard: | 1, 1.5, 1.5, 1.5, 1 |
| Step 2 | | |
| e.g | Peer Eval A: | 1, 2, 2, 2, 1 |
| Total Gap with Peers | | = 1 + 0.5 + 0.5 + 0.5 + 1 = 3.5 |
| Step 3 | | |
| Since the Total Peer Gap is 3.5, this user would be classified under “High Gap” | | |
| High Gap: | Total Peer Gap > 3 | |
| Moderate Gap: | Total Peer Gap > 1 and <= 3 | |
| Low Gap: | Total Peer Gap <= 1 | |

The gaps and the relative shapes of the pentagons 857, 858, and 859 may provide to an evaluatee an indication of his alignment with peers and coaches, and corresponding descriptions.

Evaluatee self-imbalances are determined by averaging the numerical ratings of the peers, coaches, and the self-evaluations for each evaluation criteria, and comparing them. For example, the following three sets of imbalances may be determined:
Micro-tactician vs armchair-professor
   Micro-tactician: average combined score of attributes future outlook and measuring progress is less than average score of attributes discipline in the hard stuff, speed/boldness, and truth.
   Armchair-professor: average score of attributes future outlook and measuring progress is greater than average score of attributes discipline in the hard stuff, speed/boldness, and truth.
Recklessness: average combined score of attributes future outlook and measuring progress is smaller than average score of attribute speed/boldness.
No Signal: all attributes are <= 1.5 by a peer or a coach

An overall score is determined using the average numerical ratings of the evaluations (including combinations of the self, peer and coach evaluations). For example, the overall scores may be sub-divided into categories such as foundation score (average combined score of attributes discipline in the hard stuff and truth), sense making (average combined score of attributes future outlook and measuring progress), and action (the average score of attribute speed/boldness). All three categories can be converted to expectation using thresholds such as, for example, below expectation (score <= 1.5); meets expectation (score > 1.5 and <= 2.5); exceeds expectation (score > 2.5 and <= 3.5); and far exceeds expectation (score > 3.5).

The generated information represents an evaluation of the user and can be presented in the form of a report and/or a graphical representation indicative of the identified behavioral pattern (920).

For example, the evaluation analytics application 115 may create smart radar chart(s) (e.g., 850 shown in FIG. 8A) that includes a graphical user interface (GUI) facilitating near real-time, interactive visualization of multi-dimensional data. In a smart radar chart GUI, multiple dimensions of data are displayed radiating from a central point. A radar chart is used, for example, when there is a plurality of evaluation items with respect to a certain measurement target. A circle (or another shape) is divided into sections each having an equal space according to the number of respective evaluation items, spaces to be measured are divided at equal intervals concentrically starting from the center of the circle, dots are marked at corresponding positions according to quantized scores of respective evaluation items, and the dots are connected between evaluation items to generate lines to express balance among the evaluation items. A radar chart is advantageous in that a tendency of the respective items can be easily noticed because several measurement targets are superimposed. For example, as shown in FIG. 8, the radar chart 850 shows the evaluatee self-evaluation superimposed with an average of the numerical ratings of one or more peer evaluations as well as an average of the numerical ratings of one or more coach evaluations with respect 5 evaluation criteria (namely, future outlook 851, measuring progress 852, discipline in the hard stuff 853, speed/boldness 854, and truth 855) in the form of pentagons 857, 858, and 859, respectively. The radar chart may be created using now or hereafter known methods. For example, a circle around the central point identifies the average value for the numerical ratings corresponding to each evaluation criteria and colors, shading and/or other appropriate visual indications are used to indicate whether a particular value is greater than or less than the average for that dimension as well as to differentiate self-evaluations, peer evaluations, and coach evaluations. The visualization enables a user (e.g., an evaluatee or a coach) to perceive exceptions in the data very quickly and easily, even with a large number of visualized dimensions present and/or with a small display area available for the visualization. A data point is plotted/displayed along the data dimensions to which it corresponds. The plotted data is normalized to a 50% circle, so that data points having the normal value will be plotted on the normal circle. The normal value may be, for example, the average value, expected value, or a desired value for the data. Data having a greater than normal value (positive exception) will be plotted on one side of the normal circle and data having a less than normal value (negative exception) will be plotted on the other side of the normal circle.

Next, a report is generated by identifying the traits and characteristics or behavioral competencies identified from the interpretation of the radar chart and/or evaluations (925). A specific example of a report (801) for decision making on the evaluatee from the radar chart 850 is shown in FIG. 8B. As shown in FIG. 8B, section 861 includes the generated (interactive) radar chart, and section 862 includes the identified classifications and characteristics (e.g., relationship gaps in awareness including peer and coach relationships, imbalances, and overall coach scores) with an explanation of each identified trait. The user can see the radar chart and the interpretations/classifications such as since the evaluatee has a high relationship gap with his peers/coaches, he has an extremely low self-awareness; is a micro-tactician and scores high on recklessness (imbalances); and has foundation, sense making, and action score that exceed expectations. These results are not subject to subjective analysis and can be used by the evaluatee for self-development (e.g., by selection of appropriate training modules).

The system is configured to operate in real-time. When an evaluatee selects an evaluator and solicits an evaluation, the solicitation invite with the evaluatee identifier is transmitted to the servers on which the evaluation analytics software application is implemented, and the evaluation analytics software application processes the received information to solicit evaluations. Similarly, when an evaluator selects the send command to send the evaluation message and numerical evaluation rating from the electronic device, the evaluation message, numerical evaluation rating, and identifiers are transmitted to the servers on which the evaluation analytics software application is implemented and the evaluation analytics software application processes the received information (e.g., the evaluation message, numerical evaluation rating, and identifiers) and provides them to the evaluatee. The respective users (evaluatee and/or evaluator) see the solicitation and/or evaluation message and average evaluation rating immediately, such as in 2, 3, 5, or 10 seconds or less (including milliseconds), after the evaluatee solicits an evaluation and/or an evaluator clicks on the send button. The processes(s) performed by the evaluation analytics software application refers to one or more of the aforementioned storing step (with respect to the first database 145), duplication step, removal step, storing step (with respect to the data cache and retrieval system 150), and updating step. They may further include the step of duplicating and storing the evaluator identifier in the second database 155. The system can perform all these steps in real-time in response to the evaluation giver selecting the send commend. This paragraph also applies to other commands and feeds selected by the user.

In some embodiments, the interactive training links (not shown here) may be displayed on the user interface of FIGS. 8A and 8B for navigating to trainings, development tools (or suggestions for development of skills) for improving the various gap areas and corresponding scores. Such trainings or development tools may be identified and/or developed by the software application based on the identified behavior patterns, classifications or report information.

In some other embodiments, only the evaluatee and/or those invited by the evaluatee (e.g., coaches) are allowed to access the evaluatee’s personal space or access the evaluatee’s personal evaluation information (data in their private space), such as to view in the coach’s own interface. In some such embodiments, other personnel may be allowed to view aggregated and/or anonymized evaluation data relating to at least a threshold number of evaluatees (e.g., at least three or more) in a manner such that the viewing personnel cannot associate the aggregated data with individual evaluatees. For example, personnel may be allowed to view the overall (or average) self-evaluation and/or peer/coach evaluation scores of a group including at least the threshold number of evaluatees relating to the attributes as a radar chart. One method of anonymization is to aggregate data by averaging attributes for three or more people and removing personal identifiers such as names.

Real time means that the electronic device, server, or other computer system performs an operation at a speed that appears to be instantaneous or near instantaneous (from a human perceived sense of time) in relation to when the device receives the inputs for the operation (e.g., the composed evaluation message, the selected numerical evaluation rating, etc.). The device, server, or computer system operates such that the user of the device, server, or computer system (e.g., the author or recipient of the evaluation message) perceives the output (e.g., the published and displayed evaluation message and average numerical evaluation rating) to be produced instantaneously (e.g., without appreciable delay perceived by the user) when the device receives an input or generates data, or is selected to send the received input or generated data. This also applies to sending a request from the electronic device, server, or other computer system to receiving results in the electronic device, server, or other computer system in response to the request. The user of the device, server, or computer system perceives the results to be produced instantaneously when the user sends a request from the device, server, or computer system.

The evaluation analytics software application and its servers are configured as a service within the enterprise internal data network or domain (e.g., the servers are enterprise servers of a company). The evaluation software application is configured to be installed and operate on the mobile application, for example, as an application that is installed using the mobile phone provider’s application store. In some implementations, a company may have employees download the application and the application is supported by a vendor using for example a cloud service that stores the submitted evaluation and provides the described functionality as a service to the company (e.g., as opposed to installing the software on the company’s enterprise servers).

The evaluation analytics software application is configured in an arrangement in which the evaluation software application is configured primarily as an interface for viewing and interacting with the evaluation analytics software application implemented on the enterprise servers. Preferably, processing or analysis capabilities are configured primarily or substantially only on the servers on which the evaluation analytics software application is implemented and the evaluation software application operates as an interactive viewer and data entry software client (which permits interaction with the servers and the underlying volume of data).

The schema is configured and has relationally linked data elements that are used by the evaluation analytics software application to quickly assemble different messages, ratings, or responses based on a particular situation. For example, a received request can be converted to a particular query to the service application for an individual employee’s received evaluation and the data can be retrieved from the retrieval system and second database and converted in a message (or messages) that is transmitted to the requesting evaluation analytics software application.

The evaluation analytics software application and the gateway can be implemented using a cloud application service provider. For example, a cloud provider such as Amazon can be used and the related application, databases, and system can be implemented on Amazon’s cloud (e.g., in simple terms, a data center housing servers by the cloud provider that runs applications for cloud provider’s customers, e.g., a company that wants to have the evaluation system for their company running in the cloud, and the installation and running of the software is provided as a service to those customers). Cloud-based software applications, servers, or other computer systems allow the electronic device to communicate with the applications, servers, or systems without depending on an enterprise network or intra-network. The user of the electronic device can compose a evaluation message and select evaluation rating and send both to the applications, servers, or systems from a location different or remote from where the building in which the enterprise network or intra-network is implemented and/or where the individuals are performing an activity. The user can use the evaluation software application to communicate with the evaluation analytics software application and other applications using a local network and/or telecommunication network (e.g., GSM, CDMA, 4G, etc.). Optionally, virtual container systems for providing bundled software, libraries, and configuration files for executing embodiments of the systems and methods of this invention in a manner that is isolated from other virtual machine instances/applications/data/containers for preserving security and integrity of information contained therein may be provided for certain enterprises. For example, with reference to FIG. 1, the application environment can be configured to be an operating service on a cloud services provider and supporting infrastructure such as AWS by Amazon and in some instances, as an added measure of security, an individual application environment (sometimes referred to as a docker or virtual machine) is implemented for a corresponding client of the services (the evaluation service being provided to and managed from multiple clients/companies). Otherwise, the application environment is configured to serve multiple companies/enterprise clients. In the situation where there is a specific instance for an enterprise, the application and data is separate by way of cloud infrastructure to be only running and supporting that company. The instance would not support other clients. The service provider of the evaluation application would have the system configured to update the algorithms and corresponding information for the customers via the cloud as new patterns or classifications developed.

The system is configured to work on the individual’s personal smartphone and allows them to log in to the evaluation software application from their smartphone based on the system verifying and authenticating them to be an employee at the enterprise. This then provides a security token authorizing the user to use the evaluation software application on their smartphone. The communications for logging in and subsequent application use are configured to use the existing smartphone and available network capabilities, such as communicating over a public network such as the Internet (e.g., as opposed to limiting communications within the private network of the enterprise). The ability to create a trusted environment for the user is one of the features provided by embodiments of the present invention. Through this feature, the user knows that his communications are secure and individuals on the system or who have access to the system are not random people from the public. An example of authorization process and system for establishing a trusted environment is illustratively described in the attached application.

The evaluation software application may also be a coaching software application. The coaching software application provides employees with a platform for collaborative training and skill development with a selected coach. The coaching software application allows the user to share his evaluations, goals, and skill development strategies with the people he trusts, such as coaches. By sharing, it allows the coaches to understand the current evaluations of the individual and provide the right advice and suggestions. The coaching software application provides a secure and trusted environment.

The electronic device of the evaluation recipient may notify the recipient when the recipient receives an evaluation, such as via a push notification in the status bar of the electronic device, email, text messages, or other forms of notifications.

Anonymity means that an evaluator’s identity is shielded from an evaluation recipient. The evaluation recipient is not able to identify the evaluation giver from the evaluation software application or the data provided by the evaluation processing software application to the evaluation software application. The evaluation recipient is also unable to trace the evaluation sending process to identify the evaluation giver. The data provided by the evaluation processing software application to the evaluation software application contains no sender identifier or has sender identifier encrypted.

Evaluator identifier may also include any other information that identifies the user or sender, rather the identifier, number, or code itself.

The term system refers to the overall system for soliciting, collecting, and analyzing evaluations of individuals rather than the system (e.g., evaluation processing system) within that system, unless otherwise noted.

It should be understood that in the present field, there is a distinction between feedback and evaluation. Feedback solutions are related to providing feedback on a particular action or work product of an individual while evaluation refers to an overall assessment with respect to an attribute, not specifically with respect to particular action or work product of that individual.

The illustrative systems and methods described herein include the embodiments that provide a trusted anonymous system. This can be important to accomplish because it provides a secure way to allow users to “enter” the evaluation environment for a particular company, organization, or group while at the same maintaining anonymity within the system. The combination for example can provide anonymity while also maintaining a trusted environment. This gives the users comfort that the other users are their coworkers and not the general public that can view evaluation or can comment (or troll) the system participants. This could involve checking a current employee directory before providing access to evaluation software application or other applications described in this disclosure.

An electronic device may be a desktop computer, laptop computer, a tablet computer, a cellular device, a mobile device, a smartphone, a personal digital assistant (PDA), or other similar computer system having a microprocessor and memory.

The microprocessor may include an application specific integrated circuit (ASIC), programmable logic array (PLA), digital signal processor (DSP), field programmable gate array (FPGA), or any other integrated circuit. The microprocessor may also include one or more of any other applicable processors, such as a system-on-a-chip that combines one or more of a CPU, an application processor, or a reduced instruction set computing (RISC) processor.

Memory may include volatile memory, non-volatile (non-transient) memory, or both. Volatile memory may include cache memory, semi-permanent memory such as RAM, and/or one or more types of memory used for temporarily storing computer data and instructions. Non-volatile memory may include read-only memory (ROM) or other static storage device for storing static information and instructions for the microprocessor. Software applications described in this application (e.g., evaluation software application, evaluation processing software, etc.) are implemented as computer instructions that can be stored in memory, and that are executable by or that can configure the microprocessor to perform the functions or steps described herein.

The electronic device also includes a storage device. The storage device may include a hard disk drive and/or a removable storage drive, representing a floppy disk drive, a magnetic tape drive, an optical disk drive, etc.

A network may be a communications network using any suitable communications protocol such as Wi-Fi, 802.11, Bluetooth, radio frequency systems such as 900 MHz, 1.4 GHz, and 5.6 GHz communication systems, infrared, GSM, GSM plus EDGE, CDMA, quadband, and other cellular protocols, VOIP, or any other suitable protocol. The network may also be established by using wires such as an optical fiber or Ethernet cable. A network connection interface may be a hardware device configured to support the above communications protocol such as integrated services digital network (ISDN) card, local area network (LAN) card, Ethernet card, cable modem, satellite modem, or a modem to provide a data communication connection to a corresponding type of telephone line

Server refers to a computer system or communication-oriented computer that includes the aforementioned computer components and that usually includes a faster processor, larger memory, larger storage capacity, and general capability of sustaining concurrent data communication with multiple end users, client devices, or the electronic device.

Computer system may refer to either the electronic device, the server, or other computers in this application that include a microprocessor and memory.

Although some disclosure only refers to software applications, it is understood that they also apply to the underlying computer system on which the software application is implemented.

Counterpart method and computer-readable medium embodiments would be understood from the above and the overall disclosure. Also, broader, narrower, or different combinations of the described features are contemplated, such that, for example features can be removed or added in a broadening or narrowing way.

It is understood from the above description that the functionality and features of the systems, devices, or methods of embodiments of the present invention include generating and sending signals to accomplish the actions.

It should be understood that variations, clarifications, or modifications are contemplated. Applications of the technology to other fields are also contemplated.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

Thus, for example, any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or process steps unless the description explicitly describes user intervention or manual operation.

The description primarily discusses a system or apparatus and counterpart method and non-transitory computer-readable medium embodiments would be understood from the above and the overall disclosure. Computer-readable medium may be permanent or semi-permanent memory such as hard drive, floppy drive, optical disk, flash memory, ROM, EPROM, EEPROM, etc., as would be known to those of ordinary skill in the art. Computer-readable medium stores computer instructions executable by a microprocessor, and execution of the instructions causes the microprocessor to perform the steps or functions described in this disclosure. Also, broader, narrower, or different combinations of the described features are contemplated, such that, for example, features can be removed or added in a broader or narrower way.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that, for example, may involve multiple possibilities, but to a person of ordinary skill in the art, a reasonable or primary understanding or meaning is understood.

Software can be implemented as distinct modules or software applications or can be integrated together into an overall application such as one that includes the user interface and that handles other features for providing the functionality to the user.

It is intended that the specification and examples be considered as exemplary only, with a true scope being indicated by the claims and their equivalents.

1. A computer-implemented method of providing a guided interactive self-evaluation service, comprising the steps of:
implementing an application on a server, wherein the application is configured to provide employees of a company with the service;
implementing the application to provide an interactive user interface to the employees, wherein the interactive user interface is adapted to provide individual users with an automated self-assessment process;
implementing the application to establish a private space that the individual user can configure to limit access by other employees to the user’s private space, wherein the application is configured to provide access to the private space via a browser to the individual users and is configured to invite one or more other users to have access to the individual user’s private space;
permitting the individual user to perform an automated self-evaluation using the application, the evaluation comprising numerical ratings for the five attributes and a free-style text narrative;
permitting the individual users to self-select, using the application, other employees to perform a peer-evaluation of the individual user on the service, the peer evaluation comprising the numerical ratings for the five attributes and one or more additional free style text narrative;
receiving and storing, using the server, the numerical ratings for the five attributes and the free-style text narratives;
configuring the application to store a library of algorithms that are each configured to detect a classification by detecting patterns in the numerical ratings that satisfy one of the algorithms;
detecting one or more of the classifications for individual users using the received numerical ratings for the five attributes from the self-evaluation of the individual user and a plurality of the peer evaluations for that individual user;
providing using the graphical user interface the ability for individual users to view in the individual user’s private space a structured report based on the numerical ratings from the self-evaluation and peer evaluation, and the report comprising the detected classifications for the individual user, and in conjunction with providing the structured report, display an interactive radar chart displaying the numerical ratings of the self-evaluation and a combination of other evaluations for that individual user each as a connected polygon shape;
storing the structured report including the detected classifications of the individual user; and
configuring the application to allow the users to return to use the application at later times to again perform the self-evaluation and peer evaluations and allow the user review historical data from previous reports in the private space.

2. The method of claim 1, wherein the method comprising anonymizing the evaluations such that they are not associated with identification of the one or more peers.

3. The method of claim 2, wherein the anonymizing comprising removing identification information form received evaluation as part of storing the evaluations.

4. The method of claim 1 wherein the method comprising implementing the application on a company’s enterprise network.

5. The method of claim 1 wherein the method comprising providing a list of employee of the company for user’s to select from to request peer evaluations.

6. The method of claim 1 wherein the method comprising updating the algorithms at one more later dates.

7. A non-transitory computer readable medium storing one or more software applications that causes a computer system to execute a method that implements a guided interactive self-evaluation service, the method comprising:
implementing an application on a server, wherein the application is configured to provide employees of a company with the service;
implementing the application to provide an interactive user interface to the employees, wherein the interactive user interface is adapted to provide individual users with an automated self-assessment process;
implementing the application to establish a private space that the individual user can configure to limit access by other employees to the user’s private space, wherein the application is configured to provide access to the private space via a browser to the individual users and is configured to invite one or more other users to have access to the individual user’s private space;
permitting the individual user to perform an automated self-evaluation using the application, the evaluation comprising numerical ratings for the five attributes and a free-style text narrative;
permitting the individual users to self-select, using the application, other employees to perform a peer-evaluation of the individual user on the service, the peer evaluation comprising the numerical ratings for the five attributes and one or more additional free style text narrative;
receiving and storing, using the server, the numerical ratings for the five attributes and the free-style text narratives;
configuring the application to store a library of algorithms that are each configured to detect a classification by detecting patterns in the numerical ratings that satisfy one of the algorithms;
detecting one or more of the classifications for individual users using the received numerical ratings for the five attributes from the self-evaluation of the individual user and a plurality of the peer evaluations for that individual user;
providing using the graphical user interface the ability for individual users to view in the individual user’s private space a structured report based on the numerical ratings from the self-evaluation and peer evaluation, and the report comprising the detected classifications for the individual user, and in conjunction with providing the structured report, display an interactive radar chart displaying the numerical ratings of the self-evaluation and a combination of other evaluations for that individual user each as a connected polygon shape;
storing the structured report including the detected classifications of the individual user; and
configuring the application to allow the users to return to use the application at later times to again perform the self-evaluation and peer evaluations and allow the user review historical data from previous reports in the private space.

8. The non-transitory computer readable medium of claim 7, wherein the method comprising anonymizing the evaluations such that they are not associated with identification of the one or more peers.

9. The non-transitory computer readable medium of claim 8, wherein the anonymizing comprising removing identification information form received evaluation as part of storing the evaluations.

10. The non-transitory computer readable medium of claim 7 wherein the method comprising implementing the application on a company’s enterprise network.

11. The non-transitory computer readable medium of claim 7 wherein the method comprising providing a list of employee of the company for user’s to select from to request peer evaluations.

12. The non-transitory computer readable medium of claim 7 wherein the method comprising updating the algorithms at one more later dates.

13. A computer-implemented system for providing a guided interactive self-evaluation service, comprising:
One or more computers configured using computer readable instructions stored in non-transitory computer memory to provide the service using an application, wherein the application is configured at a server and provide employees of a company with the service;
the application to configured to provide an interactive user interface to the employees, wherein the interactive user interface is adapted to provide individual users with an automated self-assessment process;
the application to configured to establish a private space that the individual user can configure to limit access by other employees to the user’s private space, wherein the application is configured to provide access to the private space via a browser to the individual user and is configured to invite one or more other users to have access to the individual user’s private space;
the application is configured to permit the individual user to perform an automated self-evaluation using the application, the evaluation comprising numerical ratings for the five attributes and a free-style text narrative;
the application is configured to permit the individual users to self-select, using the application, other employees to perform a peer-evaluation of the individual user on the service, the peer evaluation comprising the numerical ratings for the five attributes and one or more additional free style text narrative;
the application is configured receive and store, using the server, the numerical ratings for the five attributes and the free-style text narratives;
the application is configured to store a library of algorithms that are each configured to detect a classification by detecting patterns in the numerical ratings that satisfy one of the algorithms;
the application is configured to detect one or more of the classifications for individual users using the received numerical ratings for the five attributes from the self-evaluation of the individual user and a plurality of the peer evaluations for that individual user;
the application is configured to provide using the graphical user interface the ability for individual users to view in the individual user’s private space a structured report based on the numerical ratings from the self-evaluation and peer evaluation, and the report comprising the detected classifications for the individual user, and in conjunction with providing the structured report, display an interactive radar chart displaying the numerical ratings of the self-evaluation and a combination of other evaluations for that individual user each as a connected polygon shape;
the application is configured to store the structured report including the detected classifications of the individual user; and
the application is configured to allow the users to return to use the application at later times to again perform the self-evaluation and peer evaluations and allow the user review historical data from previous reports in the private space.

14. The computer-implemented system of claim 13, wherein the application is configured to anonymize the evaluations such that they are not associated with identification of the one or more peers.

15. The computer-implemented system of claim 14, wherein the application is configured to anonymize by removing identification information form received evaluation as part of storing the evaluations.

16. The computer-implemented system of claim 13, wherein the application is implemented on the company’s enterprise network.

17. The computer-implemented system of claim 13, wherein the application is configured to provide a list of employee of the company for user’s to select from to request peer evaluations.

18. The computer-implemented system of claim 13, wherein the application is configured to update the algorithms at one more later dates and applying.
